(19) United States
(12) Patent Application Publication
(10) Pub. No.: US 2009/0144084 A1
(43) Pub. Date: Jun. 4, 2009

(54) Educational Fitness and Health Training System and Method Having Research Capabilities

(76) Inventor: Ian M. Neumaier, Bridgeville, PA (US)

Correspondence Address: THE WEBB LAW FIRM, P.C., 700 KOPPERS BUILDING, 436 SEVENTH AVENUE, PITTSBURGH, PA, 15219, US

(21) Appl. No.: 12/323,538

(22) Filed: Nov. 26, 2008

Related U.S. Application Data
(60) Provisional application No. 60/990,808, filed on Nov. 28, 2007.

(51) Int. Cl. G06Q 10/00; G09B 19/00; G06Q 90/00

(52) U.S. Cl. 705/2; 705/1; 434/247

(57) ABSTRACT

A system for delivering health science education and public health information to a user includes a central database comprising information on health science education and public health information; at least one exercise facility database, located at an exercise facility, coupled to the central database; at least one accessing device located within the exercise facility allowing a user to access the health science education and public health information from the exercise facility; and at least one remote accessing device located at a remote location allowing a user to access the health science education and public health information on the central database from a remote location. The health science education and public health information includes user-controlled curriculums and tutorials featuring virtual learning approaches to exercise techniques and health science.

### CROSS REFERENCE TO RELATED APPLICATIONS

This application claims the benefit of U.S. Provisional Patent Application No. 60/990,808, entitled “Educational Fitness and Health Training System and Method”, filed Nov. 28, 2007, which is hereby incorporated by reference in its entirety.

### BACKGROUND OF THE INVENTION

1. Field of the Invention

The present invention is related, in general, to an educational fitness and health training system and method and, more specifically, to a system and method for delivering real time health science education and public health information to physical and Internet communities.

2. Description of Related Art

There are currently several devices capable of providing exercise routine instruction, exercise routine tracking methods, and even the ability to continuously adapt routine parameters based on inputs such as weight lifted, exercise performance, or completion.

For instance, United States Patent Application Publication No. 2005/0164833 to Florio is directed to an interactive training application comprising a training database. The training database provides information related to workout training. The information in the training database comprises information on a plurality of trainers and a plurality of exercise routines to work various areas of interest in the human body to obtain a desired result. The areas of interest refer to the various muscle groups of the human body that can be exercised. The information in the training database also comprises information on a plurality of gym equipment and graphic demonstration of how to use the gym equipment, with details on which muscle groups are being worked and what equipment to use to obtain the desired result. The interactive training application utilizes a stand-alone computer to install the database. The user then accesses the database to pick a virtual trainer and exercise routine to follow and updates the database with the necessary information in a tracking log.

Additionally, United States Patent Application Publication No. 2006/0040244 to Kain discloses a personal fitness system that includes a processor and a display screen. The system displays on the display screen a window with places to fill in personal data, such as age, height, weight, percent body fat, cholesterol, etc. This data is then analyzed by the processor for analysis and determination of an optimal physical fitness program. The optimal fitness program comprises a sequence of graphical images and audio content, which is displayed on the display screen. The display screen shows how a physical fitness movement of the optimal fitness program is accomplished correctly, and may use skeletal and muscle graphics in the display. The audio content may include verbal instructions on how a physical fitness movement is accomplished correctly. The processor serves as an interactive home fitness evaluator and progress log recorder that evaluates the performance of the user while performing the physical fitness program.

The intrinsic flaw found within such systems is that they rely on the user's self-assessment to generate assumptions which act as the framework for the exercise routines, progressions, targets, goals, and parameters. No way exists for the user to first calibrate what the user knows and thinks they know with what is true, prior to inputting the variables depended upon for the creation of these routines. For this reason, prior methods attempting instruction are at the mercy of the target user's knowledge calibration. The inability of non-professionals to correctly assess limitations (physiologic, anatomical, biomechanical, etc.) and needs renders useless all methods relying on inputs of the users assumptions formulated by self-assessment. Dependence on an intervening professional is required for such systems to function properly.

Therefore, these systems are detrimental to the goal of creating recognizable increases in health capital. For example, the above-described systems recognize that a great portion of the population lacks the basic knowledge to effectively and safely manage their health and exercise activities. Yet these systems employ an assumptive, input-output response for providing feedback to the consumer. Systems of limited interaction do not address the underlying limiting factor in the user which is the inability to think critically when making decisions concerning ones health.

In addition, several methods and systems are currently known for providing web-based information delivery to a student. For example, U.S. Pat. Nos. 7,029,280 to Krebs et al.; 6,704,541 to Ciarallo et al.; and 6,014,134 to Bell et al. disclose such methods and systems. Most prior art methods and systems allow an instructor to produce and input course information and multimedia for retrieval by assigned students. Learning management systems such as these are effective in delivering educational information to assigned students, but, by design, are drastically limited in their ability to apply and test different methods of information delivery. The user of the learning management systems are, for the most part, paying students who depend on the information provided by the utility in order to achieve completion of an enrolled course. Because of this, the application and testing of different methods of information delivery for empirical purposes is not possible. In addition, the use of students as research subjects comes with substantial limitations. For instance, the use of students places limits on the type of information that can be provided and the recruitment of students into an analysis course often requires providing incentives (such as extra-credit, money, etc.). Accordingly, maintaining research is costly and heavily influenced by time constraints.

U.S. Pat. No. 5,395,243 to Lubin et al. describes a method for recording the progress of students in their completion of assigned course work. It allows the compilation of student statistics but its intentions and capabilities do not allow for comparison and research protocols to be carried out, thus suffering the same limitations as the previously discussed references. All of the aforementioned examples and all similar methods and systems also lack a method for maintaining user retention. The continuous participation and interaction with users is a fundamental requisite for any information delivery and research utility to function effectively. Retention rates are a constant focus of distance learning institutions and learning management system providers.

Accordingly, a need exists for an education fitness and health training system and method that fosters qualitative feedback both to and from the user. The integration of a health facility, Internet community, and a Health Reference System (HRS) affords users with comprehensive engaging feedback, promotes user inquiry, and in this way achieves the goal of increasing public health and national health capital. A further need exists for an environment where human and computer interaction is provided in a self-directed manner, and information may be offered for the purpose of recording user statistics as required by a research protocol in order to achieve effective development of quantitative data. An additional need exists for a system that allows researchers to control the data provided to participants during research while the participant is utilizing an education fitness and health training system.

### SUMMARY OF THE INVENTION

It is an objective of the present invention to provide a method and system for delivering real-time health science education and public health information to physical and Internet communities. User-controlled curriculums and tutorials featuring virtual learning approaches (i.e., graphic animations, narration, and applied learning theories) include health science, exercise science, and other topics viable to the promotion of public health education. The system includes a Health Reference System (HRS) that allows a study to be implemented across several calibrated features (such as a virtual human anatomy model, virtual health facility, virtual human movement database, virtual exercise database, tutorials, and curriculums) in separate health and exercise facilities as well as from the user's home and other remote locations.

It is also an objective of the present invention to provide the capability of implementing and analyzing public health concepts and theory by allowing several different scientific studies to be performed simultaneously, targeting different demographic groups, without interruption in the experience of the users (i.e., learners, subjects, consumers, individuals, network, and community). Studies supported by the invention may rely on web-based programs, in-person programs, surveys, or other methods as practiced within scientific research objectives. The above-listed features are made possible by using an Internet network to integrate the infrastructure consisting of facility databases located at health and exercise facilities, Internet communities, physical communities, user interfaces, kiosk interfaces, and a central database.

The present invention is a system for delivering health science education and public health information to a user. The system includes a central database comprising information on health science education and public health information; at least one exercise facility database, located at an exercise facility, coupled to the central database; at least one accessing device located within the exercise facility allowing a user to access the health science education and public health information from the exercise facility; and at least one remote accessing device located at a remote location allowing a user to access the health science education and public health information on the central database from a remote location. The health science education and public health information includes user-controlled curriculums and tutorials featuring virtual learning approaches to exercise techniques and health science.

The at least one remote accessing device may be a personal computer at a home of the user. The at least one remote accessing device may be a kiosk located at a remote location. The at least one accessing device may be a touch screen monitor, a kiosk, or any combination thereof. The at least one exercise facility database and the at least one remote accessing device may be coupled to the central database via the Internet.

The present invention is also a method of delivering health science education and public health information to a user. The method includes the steps of: creating a central database comprising information on health science education and public health information; providing at least one exercise facility database located at an exercise facility that is coupled to at least one accessing device and to the central database; and providing at least one remote accessing device located at a remote location and coupled to the central database. The user is capable of accessing the health science education and public health information on the central database from either the at least one accessing device or the at least one remote accessing device to obtain the health science education and public health information. The health science education and public health information includes user-controlled curriculums and tutorials featuring virtual learning approaches to exercise techniques and health science.

The at least one remote accessing device may be a personal computer at a home of the user. The at least one remote accessing device may be a kiosk located at a remote location. The at least one accessing device may be a touch-screen monitor, a kiosk, or any combination thereof. The at least one exercise facility database and the at least one remote accessing device may be coupled to the central database via the Internet.

The present invention is also directed to a system for conducting research. The system includes a central server; at least one exercise facility database coupled to the central server; at least one member interface device allowing at least one member to access the central server; and at least one researcher interface allowing at least one researcher to access the central server and deliver research information to the member. The at least one exercise facility database is located at an exercise facility and includes information regarding each of the members of the exercise facility stored thereon. The at least one researcher delivers research information to the at least one member via the central server and the at least one member provides responses to the research information to the at least one researcher via the central server.

The central server may also store information on health science education and public health information. The at least one member may access the health science education and public health information on the central server using the at least one member interface device. The health science education and public health information may include user-controlled curriculums and tutorials featuring virtual learning approaches to exercise techniques and health science. The at least one member interface device may be a personal computer at a home of the user, a kiosk located at a remote location, a touch-screen monitor located at the exercise facility, a kiosk located at the exercise facility, or any combination thereof. The at least one researcher interface device may be a personal computer. The research information may be a tutorial, a survey, a test, or any combination thereof. The at least one research interface device and the at least one member interface device may be coupled to the central server via the Internet. The at least one member interface device may allow the at least one member to access the exercise facility database such that the at least one member can update information stored thereon.

These and other features and characteristics of the present invention, as well as the methods of operation and functions of the related elements of structures, will become more apparent upon consideration of the following description and the appended claims with reference to the accompanying drawings, all of which form a part of this specification, wherein like reference numerals designate corresponding parts in the various figures. As used in the specification and the claims, the singular form of “a”, “an”, and “the” include plural referents unless the context clearly dictates otherwise.

### BRIEF DESCRIPTION OF THE DRAWINGS

FIG. 1 is a block-diagram illustrating a network for implementing the present invention;

FIG. 2 is a an exemplary system in which the kiosks used with the system of the present invention may be implemented, including a general-purpose computing device;

FIG. 3 is a flow-diagram showing a representation of the access of the central database via the off-site kiosks;

FIG. 4 is a block-diagram illustrating the interaction of a user's personal computer with the system of the present invention;

FIG. 5 is a flow-diagram illustrating the creation of an HRS for an exercise facility;

FIG. 6 is an alternative representation of Matrix One of FIG. 4;

FIG. 7 is an example of a screen shot illustrating an exercise facility floor plan;

FIG. 8 is a block-diagram illustrating an interactive lesson performed using the system of the present invention at an exercise facility;

FIG. 9 is a flow-diagram illustrating the use of the system of the present invention to retrieve health information related to cardiovascular equipment;

FIG. 10 is an alternate embodiment of an example of a screen shot illustrating an exercise facility floor plan;

FIG. 11 is an example screen shot illustrating a virtual human using an elliptical machine;

FIG. 12 is an example screen shot illustrating a virtual human using an elliptical machine with the muscular system of the virtual human exposed;

FIG. 13 is a flow-diagram illustrating the use of the system of the present invention to retrieve health information related to strength-training equipment;

FIG. 14 is an example screen shot illustrating a virtual human using a Smith machine with the muscular system of the virtual human exposed;

FIG. 15 is a flow-diagram illustrating the use of the Anatomy Model of the system of the present invention;

FIG. 16 is an example screen shot illustrating the use of the Anatomy Model of the system of the present invention;

FIG. 17 is a flow-diagram illustrating the use of keyword searches to determine information from the HRS in accordance with the present invention;

FIG. 18 is a flow-diagram illustrating the use of equipment labels to determine information from the HRS in accordance with the present invention;

FIG. 19 is a block-diagram illustrating the manner in which the system of the present invention provides an environment fostering scientific study and research;

FIGS. 20A and 20B are a flow-diagram illustrating the use of the system of the present invention for scientific study and research;

FIG. 21 is a block-diagram illustrating an alternative manner in which the system of the present invention provides an environment fostering scientific study and research;

FIG. 22 is a block diagram illustrating the manner in which the system of the present invention can provide a network for use in scientific study and research;

FIG. 23 provides a graphical representation of how the system of the present invention creates, collects, applies and updates user information; and

FIG. 24 is a flow-diagram illustrating the manner in which the system of the present invention adds and stores user information.

### DETAILED DESCRIPTION OF THE PRESENT INVENTION

For purposes of the description hereinafter, the terms “upper”, “lower”, “right”, “left”, “vertical”, “horizontal”, “top”, “bottom”, “lateral”, “longitudinal”, and derivatives thereof shall relate to the invention as it is oriented in the drawing figures. However, it is to be understood that the invention may assume various alternative variations, except where expressly specified to the contrary. It is also to be understood that the specific devices illustrated in the attached drawings, and described in the following specification are simply exemplary embodiments of the invention. Hence, specific dimensions and other physical characteristics related to the embodiments disclosed herein are not to be considered as limiting.

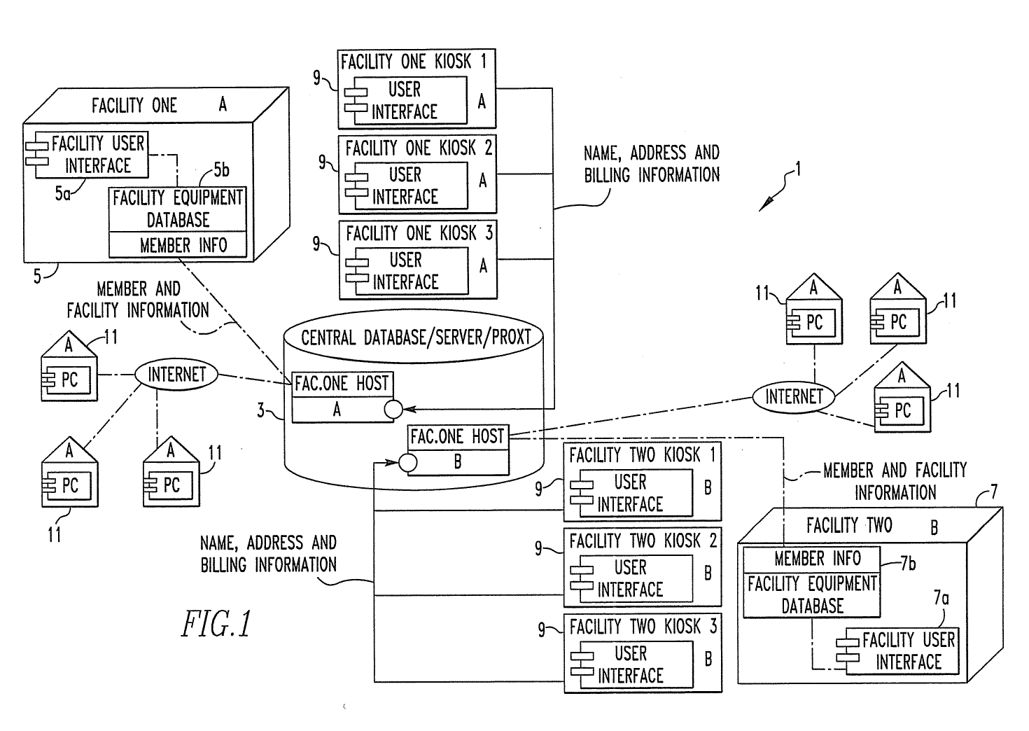

With reference to FIG. 1, a system 1 for delivering health science education and public health information to a user (i.e., the HRS) includes a central database 3, a first exercise facility 5, and a second exercise facility 7. The central database 3 includes information on health science education and public health information. Within each exercise facility 5, 7 is a user interface 5a, 7a and two databases 5b, 7b external from the user interface 5a, 7a. One of the databases indexes all the specific exercise facility information including layout, equipment, amenity, and the HRS information, while the other database indexes all members and membership information. Each exercise facility database 5b, 7b is coupled to the central database 3, and the user interface 5a, 7a allows a user to access the health science education and public health information from the exercise facility 5, 7. User interface 5a, 7a may be a touch-screen monitor or a kiosk having a touch-screen monitor. While system 1 has been described as including a first exercise facility 5 and a second exercise facility 7, this is not to be construed as limiting the present invention as any number of exercise facilities may be included as part of system 1.

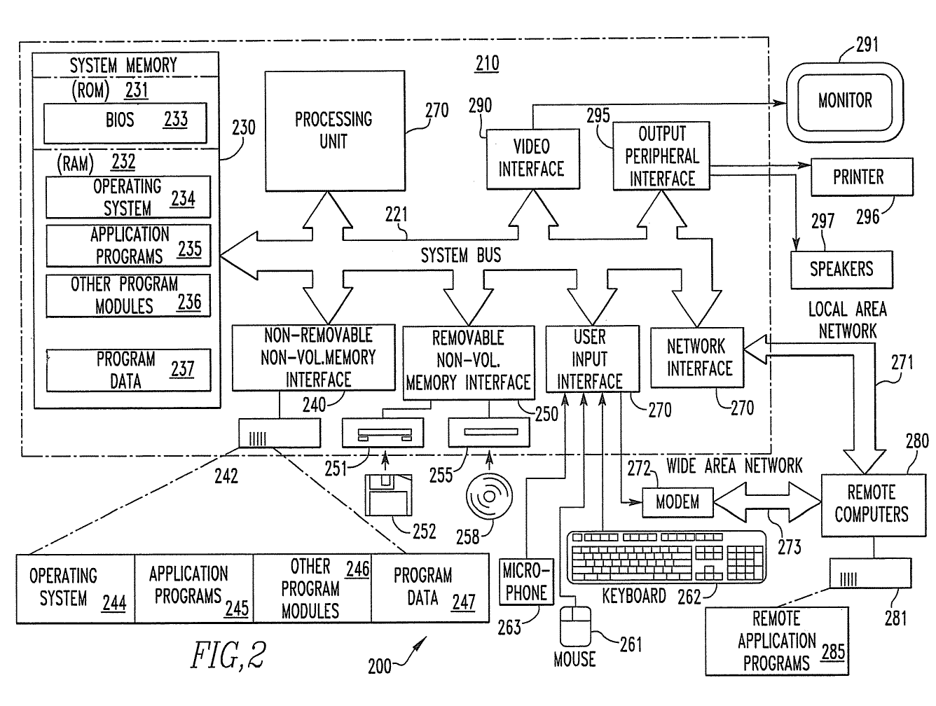

System 1 further includes a plurality of off-site kiosks 9 and a plurality of user personal computers 11. Off-site kiosks 9 may be located in a mall, sporting-goods store, or the like. FIG. 2 and the following discussion are intended to provide a brief, general description of the components of kiosks 9 and the environment in which the method of the present invention may be implemented. FIG. 2 provides a block diagram of an exemplary kiosk 9 that may correspond in whole or in part to a general-purpose computing device, and is shown as a computing system environment 200. Components of the computing system environment 200 may include, but are not limited to, a computing device 210 having a processing unit 220, a system memory 230, and a system bus 221 that couples various system components including the system memory to the processing unit 220. The system bus 221 may be any of several types of bus structures including a memory bus or memory controller, a peripheral bus, or a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

The computing system environment 200 typically includes a variety of computer-readable media products. Computer-readable media may include any media that can be accessed by the computing device 210 and include both volatile and non-volatile media, removable and non-removable media. By way of example, and not of limitation, computer-readable media may include computer storage media and communications media. Computer storage media includes both volatile and non-volatile, removable and non-removable media implemented in any method or technology for storage of information such as computer-readable instructions, data structures, program modules, or other data. Computer storage media include, but are not limited to, random-access memory (RAM), read-only memory (ROM), electrically erasable programmable read-only memory (EEPROM), flash memory, or other memory technology, CD-ROM, digital versatile disks (DVDs), or other optical disk storage, magnetic cassettes, magnetic tape, magnetic disk storage, or other magnetic storage devices, or any other medium which can be used to store the desired information and which can be accessed by the computing device 210. Communications media typically embody computer-readable instructions, data structures, program modules, or other data in a modulated data signal such as a carrier wave or other transport mechanism and include any information delivery media. By way of example, and not limitation, communications media include wired media such as a wired network and a direct-wired connection and wireless media such as acoustic, RF, optical, and infrared media. Combinations of any of the above should also be included within the scope of computer-readable media.

The system memory 230 includes computer storage media in the form of volatile and non-volatile memory such as ROM 231 and RAM 232. A basic input/output system (BIOS) 233, containing the basic routines that help to transfer information between elements within the computing device 210, such as during start-up, is typically stored in ROM 231. RAM 232 typically contains data and program modules that are immediately accessible to or presently being operated on by processing unit 220. By way of example, and not limitation, FIG. 2 illustrates an operating system 234, application programs 235, other program modules 236, and program data 237. Often, the operating system 234 offers services to application programs 235 by way of one or more application programming interfaces (APIs) (not shown). Because the operating system 234 incorporates these services, developers of application programs 235 need not redevelop code to use the services. Examples of APIs provided by operating systems, such as Microsoft® Windows, are well known in the art.

The computing device 210 may also include other removable/non-removable, volatile/non-volatile computer storage media products. By way of example only, FIG. 2 illustrates a non-removable, non-volatile memory interface (hard disk interface) 240 that reads from and writes to non-removable, non-volatile magnetic media; a magnetic disk drive 251 that reads from and writes to a removable, non-volatile magnetic disk 252; and an optical disk drive 255 that reads from and writes to a removable, non-volatile optical disk 256 such as a CD ROM. Other removable/non-removable, volatile/non-volatile computer storage media that can be used in the exemplary operating environment include, but are not limited to, magnetic tape cassettes, flash memory cards, DVDs, digital video tape, solid state RAM, and solid state ROM. The hard disk drive 241 is typically connected to the system bus 221 through a non-removable memory interface, such as the interface 240, and magnetic disk drive 251 and optical disk drive 255 are typically connected to the system bus 221 by a removable non-volatile memory interface, such as interface 250.

The drives and their associated computer storage media discussed above and illustrated in FIG. 2 provide storage of computer-readable instructions, data structures, program modules, and other data for the computing device 210. In FIG. 2, for example, hard disk drive 241 is illustrated as storing an operating system 244, application programs 245, other program modules 246, and program data 247. Note that these components can either be the same as or different from the operating system 234, application programs 235, other program modules 236, and program data 237. The operating system 244, application programs 245, other program modules 246, and program data 247 are given different numbers here to illustrate that, at a minimum, they are different copies. A user may enter commands and information into the computing device 210 through input devices such as a microphone 263, keyboard 262, and pointing device 261, commonly referred to as a mouse, trackball, or touch pad. Kiosk 9 desirably includes a touch-screen monitor as the input device. Other input devices (not shown) may include a joystick, game pad, satellite dish, and scanner. These and other input devices are often connected to the processing unit 220 through a user input interface 260 that is coupled to the system bus, but may be connected by other interface and bus structures, such as a parallel port, game port, or a universal serial bus (USB). A monitor 291 or other type of display device is also connected to the system bus 221 via an interface, such as a video interface 290. In addition to the monitor, computing device 210 may also include other peripheral output devices such as speakers 297 and printer 296, which may be connected through an output peripheral interface 295.

The computing system environment 200 may operate in a networked environment using logical connections to one or more remote computers, such as a remote computer 280. The remote computer 280 may be a personal computer, a server, a router, a network PC, a peer device, or other common network node, and typically includes many or all of the elements described above relative to the computing device 210, although only a memory storage device 281 has been illustrated in FIG. 2. The logical connections depicted in FIG. 2 include a local area network (LAN) 271 and a wide area network (WAN) 273, but may also include other networks such as a personal area network (PAN) (not shown). Such networking environments are commonplace in offices, enterprise-wide computer networks, intranets, and the Internet.

When used in a LAN networking environment, the computing system environment 200 is connected to the LAN 271 through a network interface or adapter 270. When used in a WAN networking environment, the computing device 210 typically includes a modem 272 or other means for establishing communications over the WAN 273, such as the Internet. The modem 272, which may be internal or external, may be connected to the system bus 221 via the user input interface 260, or via another appropriate mechanism. In a networked environment, program modules depicted relative to the computing device 210, or portions thereof, may be stored in a remote memory storage device. By way of example, and not limitation, FIG. 2 illustrates remote application programs 285 as residing on memory device 281. It will be appreciated that the network connections shown are exemplary and other means of establishing a communications link between the computers may be used.

Users may utilize a computer to access their account, view HRS features (as will be discussed in greater detail hereinafter) for an exercise facility, create and maintain a personal page domain for others to view, track progress, and network with others. One feature of system 1 is that qualitative health data for individuals across a wide demographic is made available and may be compared considering other controlled variables such as the controlled environment of the exercise facilities, Internet programs administered, and/or in-person programs administered by public health professionals.

When a user connects to the Internet and accesses an exercise facility's website, he is prompted to enter a username and password. This combination is recognized by central database 3 and the user is forwarded to his exercise facilities network (containing other facilities within the same area code). Users within exercise facility 5, 7 may access the same information using user interface 5a, 7a located within exercise facility 5, 7.

When off-site kiosk 9 is used to complete a new membership account because of the private information required (such as contact and billing information), the connection of kiosk 9 is provided to central database 3 where the information is encrypted and then shared with exercise facility database 5b or 7b belonging to the new user's membership.

With reference to FIG. 2, and with continuing reference to FIG. 1, off-site kiosks 9 are designed to allow sales and information delivery from outside of exercise facilities 5, 7. Off-site kiosks 9 offer limited reference and are intended primarily to serve those considering exercise and health education by allowing them to take virtual tours of exercise facility 5 or 7 and explore the features provided with the purchase of a facility or online membership. Off-site kiosks 9 are coupled to central database 3 via the Internet and allow users to create a facility membership and begin using the facility and all interactive features immediately.

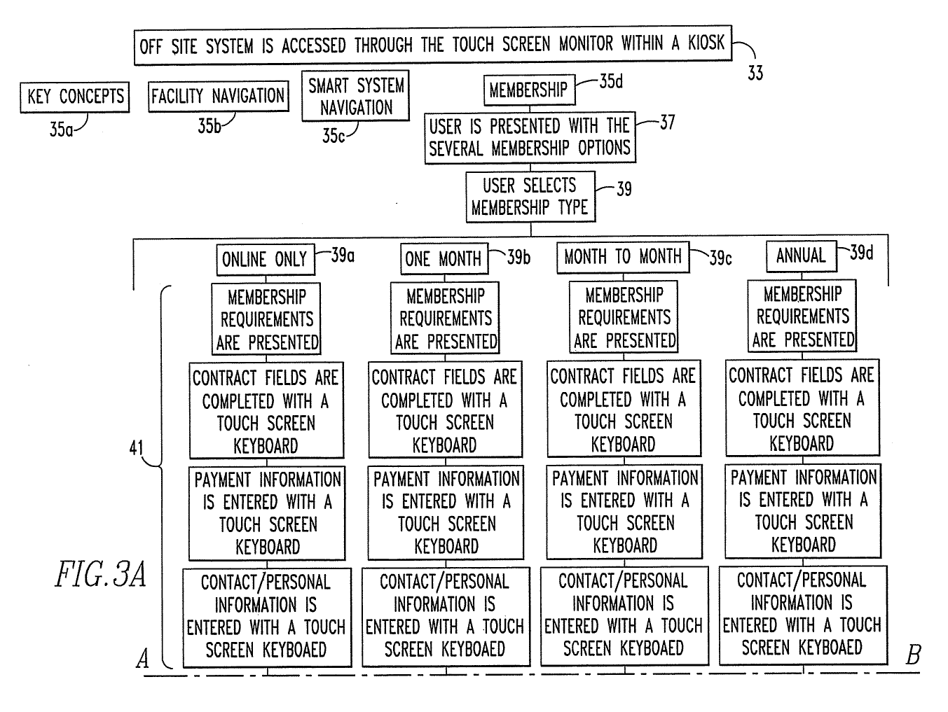

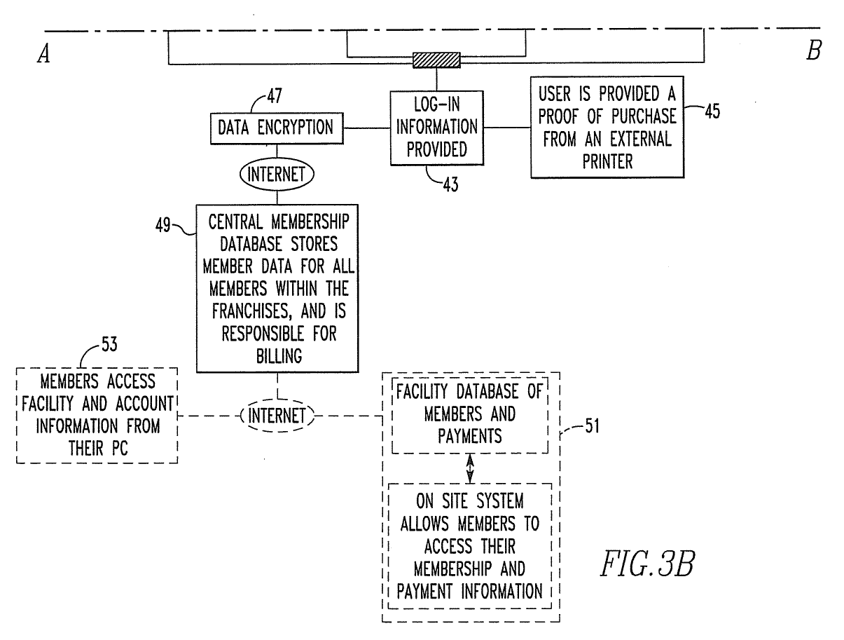

With reference to FIG. 3, and with continuing reference to FIGS. 1 and 2, off-site kiosks 9 function in the following manner. First, a user approaches off-site kiosk 9 which is located at a mall, sporting-goods store, or other location. At step 33, the user activates the touch-screen within an off-site kiosk 9. The user can then choose from key concepts 35a, virtual facility navigation 35b, smart system navigation 35c, and membership 35d by selecting the appropriate touch-screen button. Virtual facility navigation 35b allows the user to take a tour of the facility they are interested in learning more about. Smart system navigation 35c offers a virtual tutorial explaining the use of the HRS. The membership 35d section provides the available membership types allowing access to the full HRS reference and/or one of the franchise facilities. A user wishing to explore membership options after touching the button corresponding to membership 35d are presented with the available membership options (step 37). The types of available membership are provided at 39 and are as follows: Online only 39a (Online only membership allows full use of the HRS online with no selected facility. Online only members may create personal page domains and connect with other users within the area code of their contact information), One Month 39b, Month to Month 39c and Annual 39d. At 41, each membership type has different requirements. These requirements, along with membership prices, are presented to the user and their input is collected through the online sign-up methods of off-site kiosk 9. Information is collected using an on-screen keyboard.

Thereafter, at step 43, once all information has been collected and approved for submission, the new user's log-in information is provided. A proof of purchase and membership log-in information is sent to a printer within the kiosk at step 45. Additionally, the data is encrypted and sent, via the Internet, to the central database 3 at step 47. Thereafter, at step 49, information is added to central database 3. Then, the information is forwarded, via the Internet, to the facility database for the selected facility at step 51. The new member may now access their account information and personal domain using the facility HRS. Finally, at step 53, the new user can access his or her account information and personal domain using any device with Internet access.

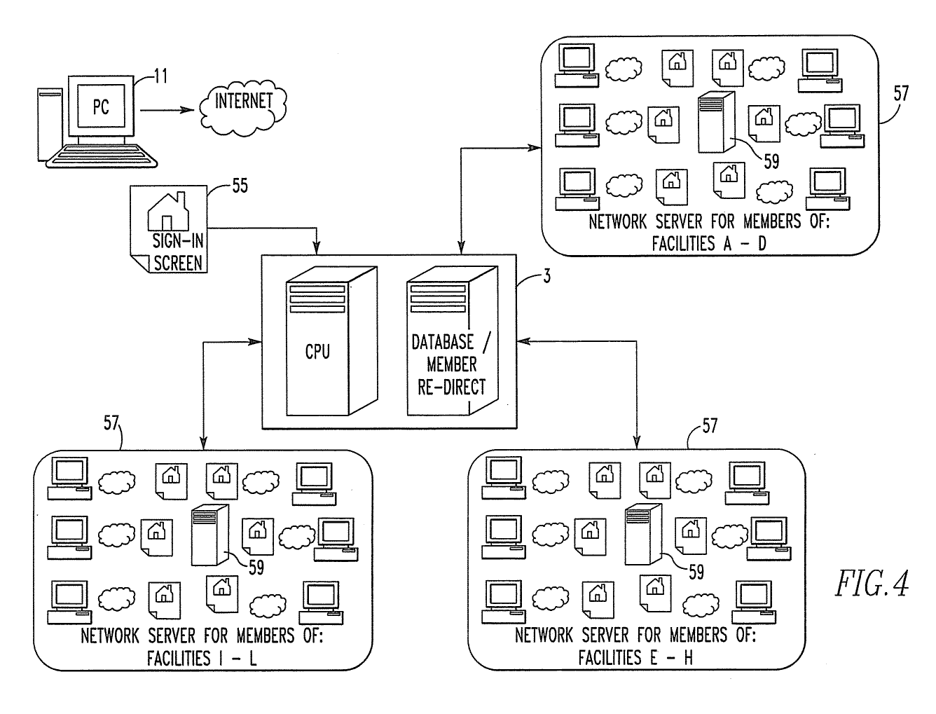

With reference to FIG. 4, and with continuing reference to FIGS. 1-3, a block diagram illustrating the interaction of a user's personal computer with system 1 is illustrated. FIG. 4 is a representation of the relationship between a user's personal computer or any other suitable device with Internet access, the HRS website and servers, and the social networks created. A user accesses the Internet to connect with the HRS website 55. The website's homepage provides space for members to enter the required log-in information, which they received upon creating a membership. Each user's unique set of username and password allows access to the HRS online reference and community which is provided on central database 3. When log-in information is provided, central database 3 is responsible for recognizing the members corresponding exercise facility location, and routing them to the correct facility network server according to this information. When redirection is complete, the user is presented with their personal domain page. Users may now explore the HRS material for their facility, add and edit portions of his or her personal page, and network with and visit pages of other users within the network. Each facility network 57 is made up of many members from the facilities located within a determined distance from each other (e.g., all facilities within an area code, etc.). This allows users the ability to network with others who may not share a membership to the same facility but live within a relatively small distance of one another. A separate server 59 handles the individual facilities equipment database and membership database.

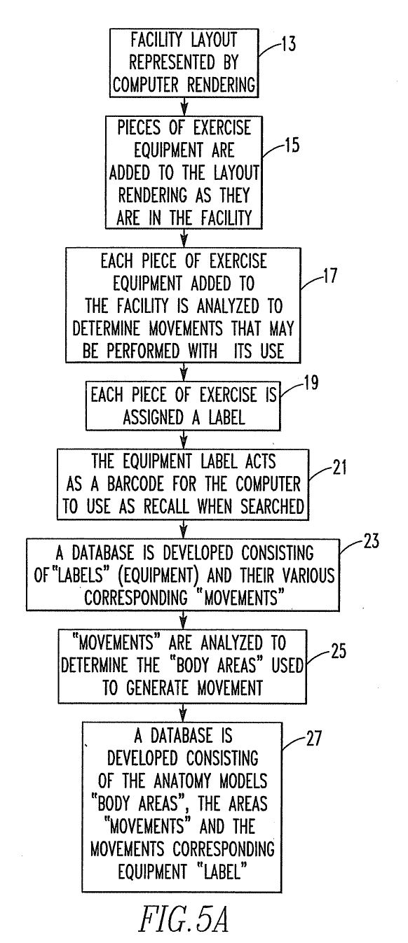

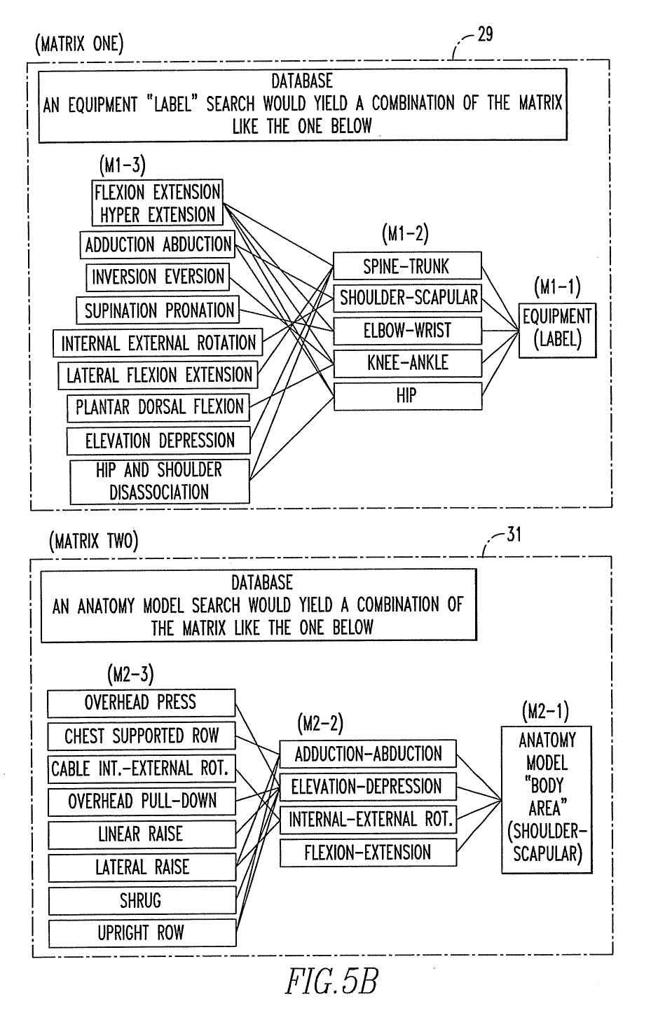

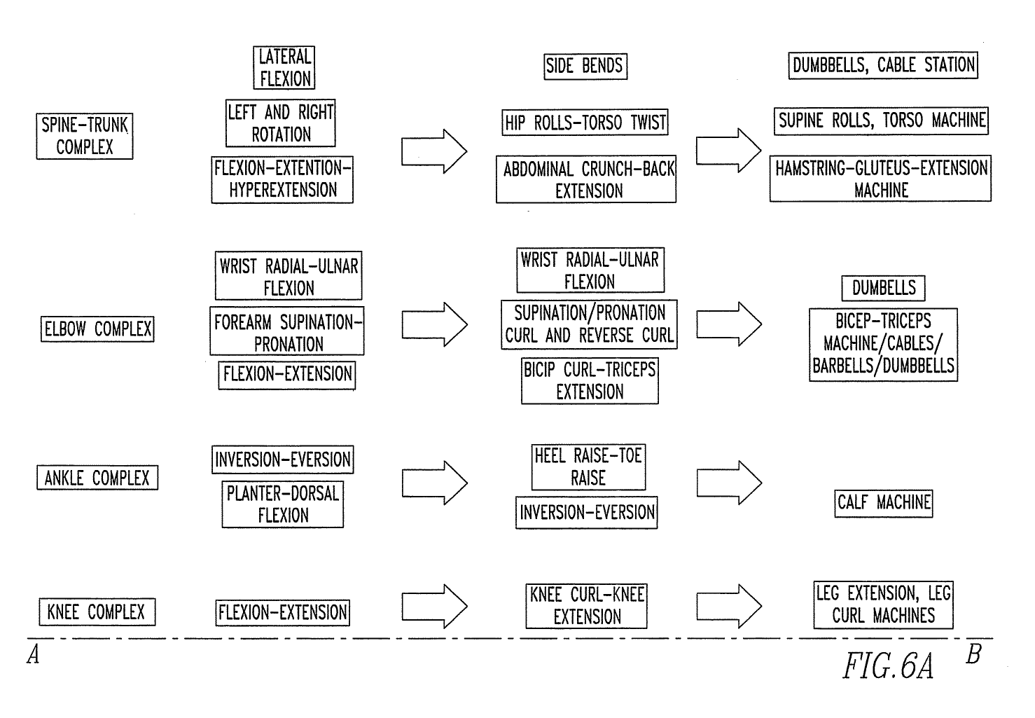

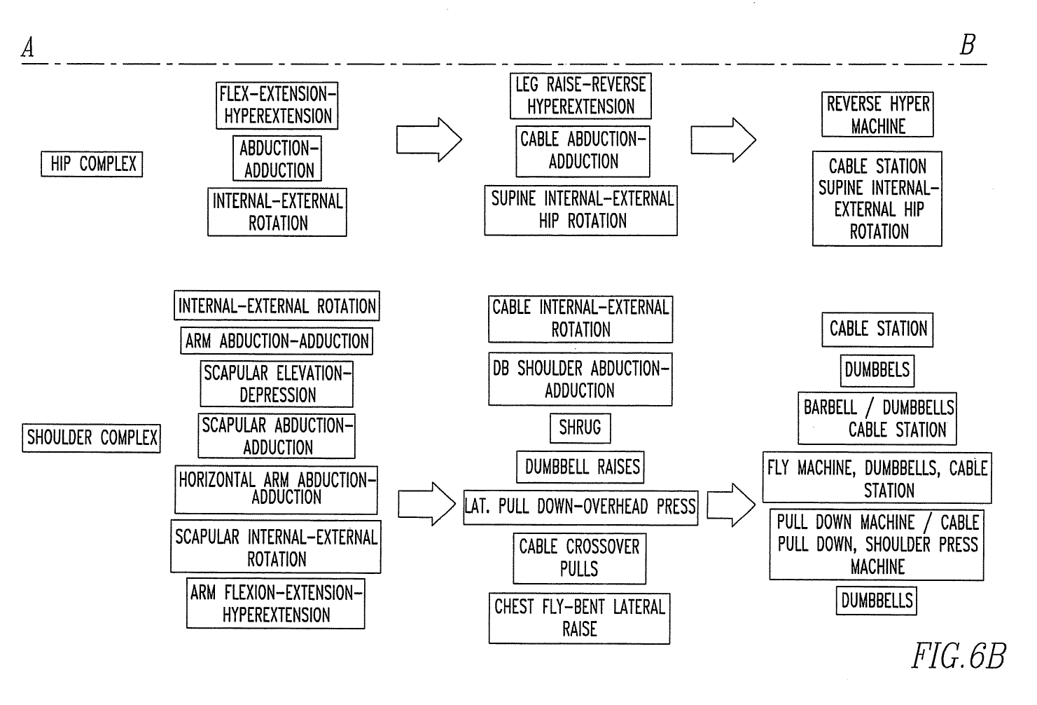

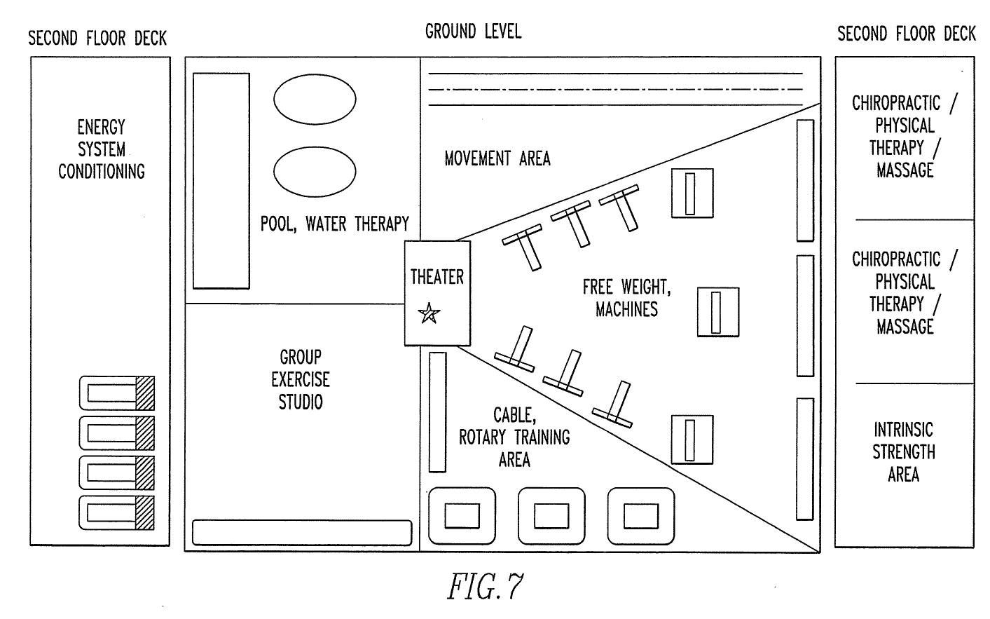

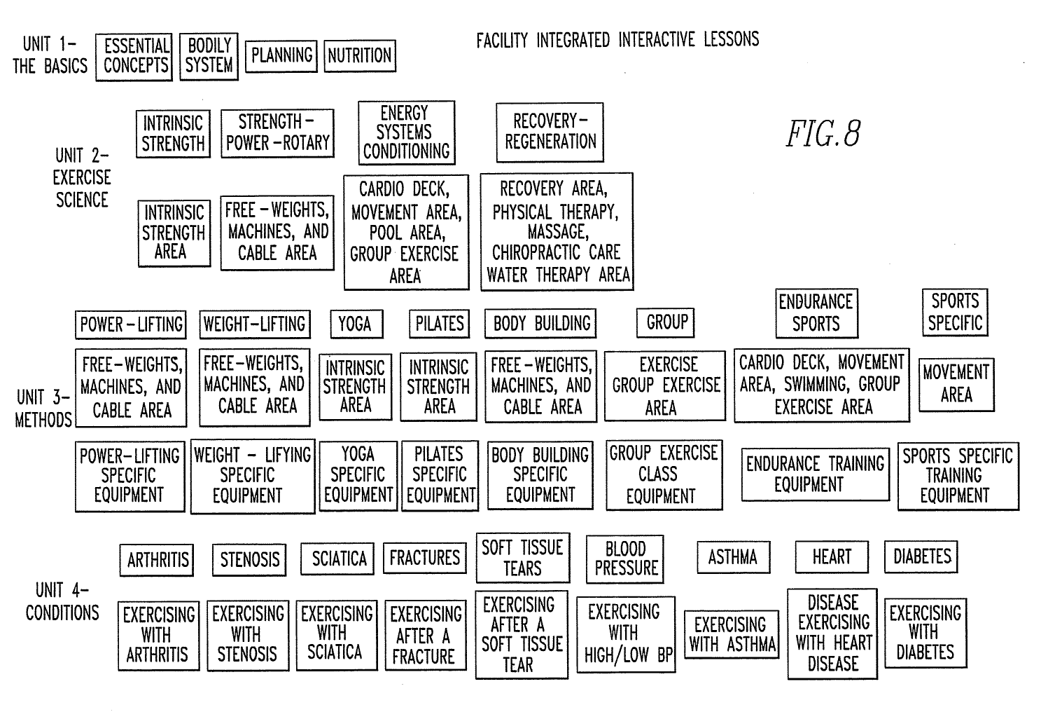

With reference to FIGS. 5 and 6, and with continuing reference to FIGS. 1-4, the development of facilities databases 5b, 7b to be used as part of the HRS is illustrated. First, at step 13, when an exercise facility is selected as a franchise building, its layout is re-created as a graphical interface. The exercise facility becomes the model of a landscape to be traversed virtually via the HRS and the members' personal computer via the Internet. Next, at step 15, as the exercise facility is built and equipment is organized, so too is the computer rendering. Equipment graphics will be placed on the computer rendering, just as they are within the facility, as shown in FIG. 7 as will be discussed hereinafter. Thereafter, at step 17, since each piece of equipment has a limited number of exercises that may be performed with its use, these use limitations and variations are determined and noted for the creation of animated examples of each exercise for each piece of equipment. At step 19, each piece of equipment is provided a label to allow for fast reference and search functions. The label is a representation of a piece of exercise equipment and its possible movements. At step 21, the user of the HRS will use only the label in practice, and the computer database is responsible for relating the searched label to its corresponding movements and exercises. Then, at step 23, an equipment-exercise database is created that includes the facility equipment and the articulations allowed by that equipment. Just as the equipment was analyzed for the exercises it provides, each exercise is analyzed at step 25 to determine the area of the body it affects, and the details of this effect, for example, Shoulder-Flexion and Extension versus Shoulder Abduction and Adduction and the like. Finally, at step 27, an extension of the equipment-exercise database is created. This database is the movement-anatomy model database. A user's search of the Anatomy Model displays the HRS' ability to relate the body area selected to the body's corresponding movements and, therefore, the facility equipment that provides the use of this selected body area.

FIG. 5 also shows matrix representations of the equipment-exercise database and the movement-anatomy model database. The manner in which the HRS is able to provide qualitative feedback is displayed in these two matrices. Matrix One 29 demonstrates the search of an equipment label and the resulting response from the HRS. For example, Matrix One's search of an equipment label returns with the exercise equipment shown mounted and or in use by a Virtual Anatomy Model ([M1-1]). Then, areas of the body most active during the performance of the movement are highlighted ([M1-2]). Finally, a user's selection of the body area returns specific articulation and highlights ([M1-3]). FIG. 5 illustrates another representation of Matrix One 29 where relationships between body area, articulation, and exercise are shown as text in a lateral flow.

Matrix Two 31 demonstrates the search of a specific area of the Virtual Human Anatomy Model. In Matrix Two 31, the search of a body area (e.g., the shoulder) ([M2-1]) leads to articulations available to this area of the body ([M2-2]). Then, selection of a specific articulation returns examples of that movement being performed with facility exercise equipment ([M2-3]).

With reference to FIG. 7, a possible exercise facility layout is illustrated. This illustration is for explanatory purposes only and should not be construed as to limit the present invention as any possible floor plan has been envisioned. The areas of the facility each have a specific application within the exercise and health education curriculum as recognized by health and exercise science. Not all areas are separated from one another; instead, the equipment configuration, floor material, and equipment label color provides borders which correspond to equipment search functions, facility navigation functions, and the HRS Curriculum. Each recognized area relates to a specific focus of the virtual tour, introduction, key concepts, and other tutorials as will be discussed hereinafter. A computerized representation of this facility layout is one of the possible screens that can be accessed on user interface 5a, 7a within facility 5, 7. The touch of a user on the screen of user interface 5a, 7a highlights equipment and reveals the equipment's name and label. Another tap opens the area of the HRS providing the selected equipment's information as will be discussed hereinafter.

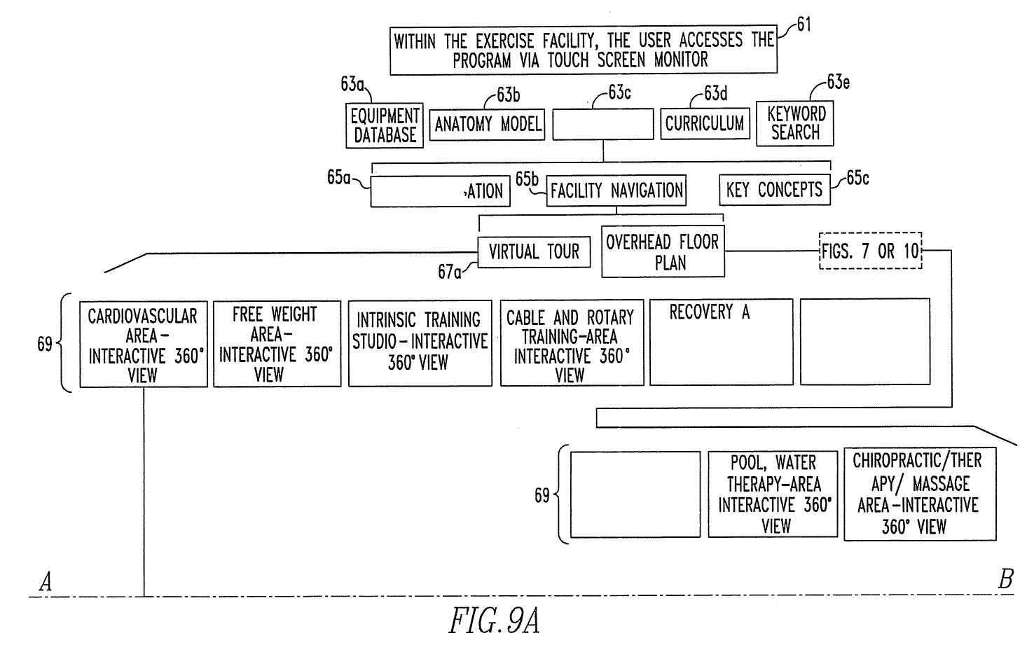

With reference to FIG. 8, an example of how one type of curriculum can be integrated with the exercise facility and the HRS is illustrated. In this example, users are presented with programs teaching the science of health and exercise and then presented with the methods of application as can be applied within the health facility. A section explaining aspects of different conditions and how to exercise with these conditions is another possibility.

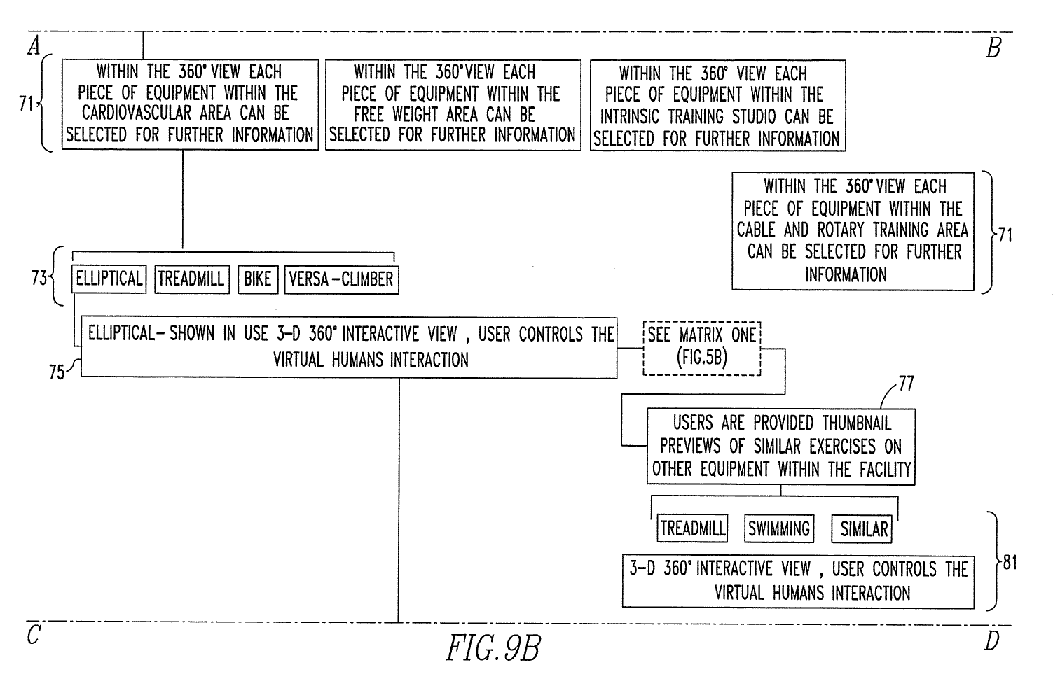

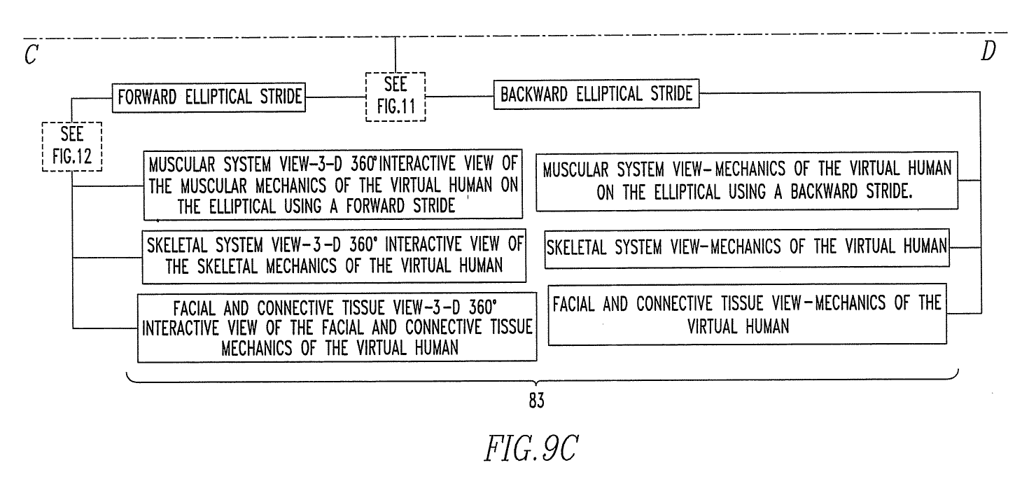

With reference to FIG. 9, and with continuing reference to FIGS. 1-4, a flow-diagram demonstrating the use of the HRS to view and retrieve information on facility equipment by an on-site user is provided. In this instance, the user utilizes the HRS introduction link and chooses to take a virtual tour of the facility and retrieves further information on specific equipment within the cardiovascular area of the exercise facility.

The method used by the user to retrieve such information is as follows: first, at step 61, the user within exercise facility 5 or 7 activates the HRS by touching the screen on user interface 5a or 7a thereby providing a home screen from which the user may select from the links available. These links include, but are not limited to, equipment database 63a having information related to facility equipment, anatomy model 63b utilizing a virtual human to demonstrate the areas of the body used on facility equipment and during movement, an introduction 63c which contains a plurality of educational tutorials and walk-throughs for users, curriculum 63d having educational tutorials regarding exercise science and a keyword search 63e which allows users to search central database 3.

If the user selects introduction 63c, several additional links appear on the touch screen including, but not limited to, system navigation 65a which provides the user step-by-step visual instruction on use of the smart system, facility navigation 65b providing a plurality of facility navigation tools to the user and key concepts 65c which provides highlights of the curriculum to those new to the facility and/or exercise.

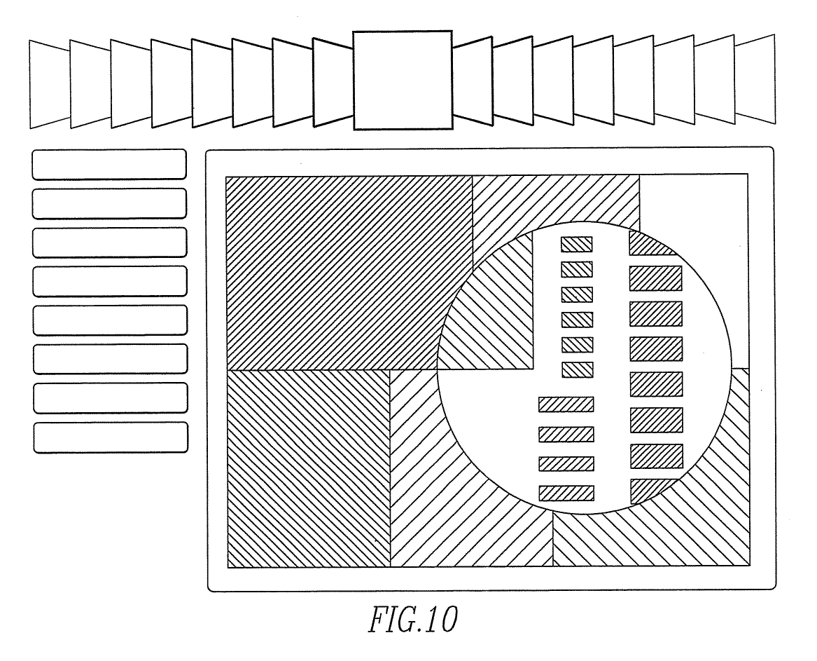

If the user selects the facility navigation 65b link, several more links appear on the touch-screen including, but not limited to, virtual tour 67a which presents a guided first-person tour of the facility, or overhead floor plan 67b link which allows users to view the facility layout and all the exercise areas from an overhead camera angle and to select specific areas to view in more detail (see FIG. 7 or FIG. 10).

The blocks 69 represent some of the exercise areas within exercise facility 5 or 7 that the users may tour, search and/or research within the HRS. The blocks 71 represent the ability of the user to select any individual piece of equipment from the virtual tour or the overhead floor plan for further information. The blocks 73 represent individual pieces of equipment that can be viewed within the cardiovascular area as viewed through the virtual tour and/or overhead plan.

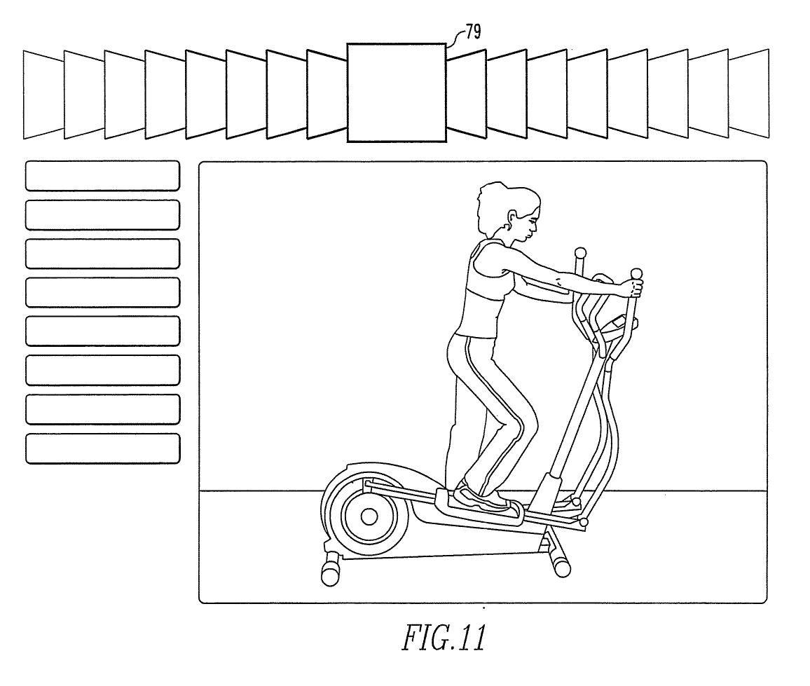

An example of the use of system 1 is as follows: if the user touch-selects the elliptical, at block 75 for example, this piece of equipment is isolated and shown in use by a virtual human (see FIG. 11). System 1 also has the ability to present the user with equipment and/or movements similar or deemed related to that of the elliptical (see block 77). Examples of such equipment and movements are shown in blocks 81. System 1 has an additional ability to toggle between pluralities of uses of one piece of equipment by flipping through a variety of images 79 on the touch screen monitor (see FIG. 11).

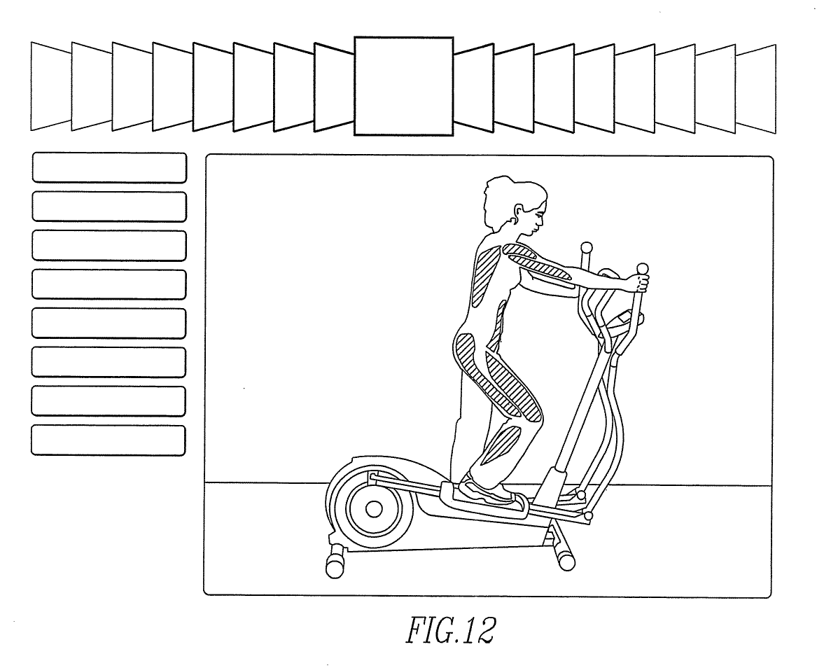

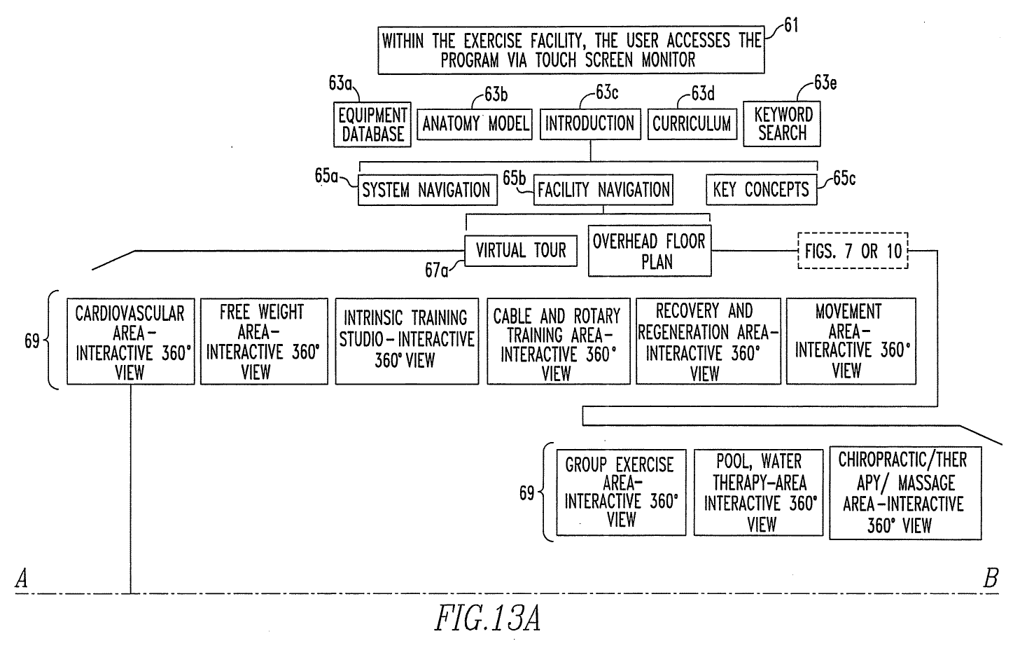

Another feature is that system 1 can show the elliptical in use by the virtual human from a Muscular system view. Within this view, muscle action specific to the use of the elliptical is highlighted and explained (see FIG. 12). System 1 is also capable of showing the elliptical in use by the virtual human from a Skeletal system view. Within this view, skeletal action specific to the use of the elliptical is highlighted and explained. Finally, system 1 has the ability to show the elliptical in use by the virtual human from a Fascial and Connective Tissue view. Within this view, fascial and connective tissue action specific to the use of the elliptical is highlighted and explained (see blocks 83).

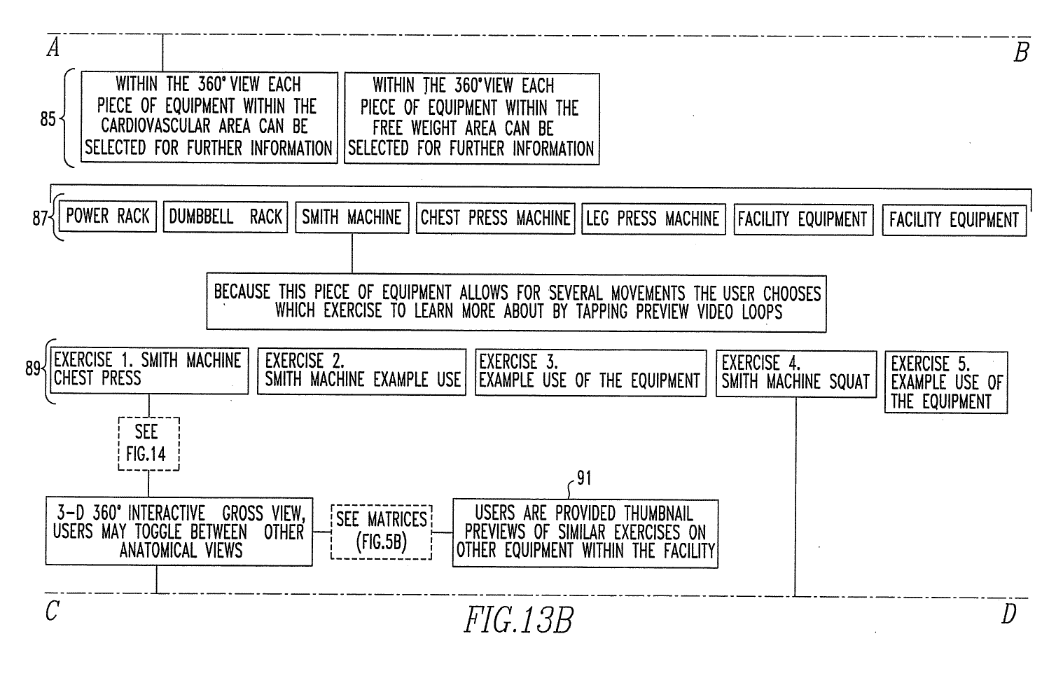

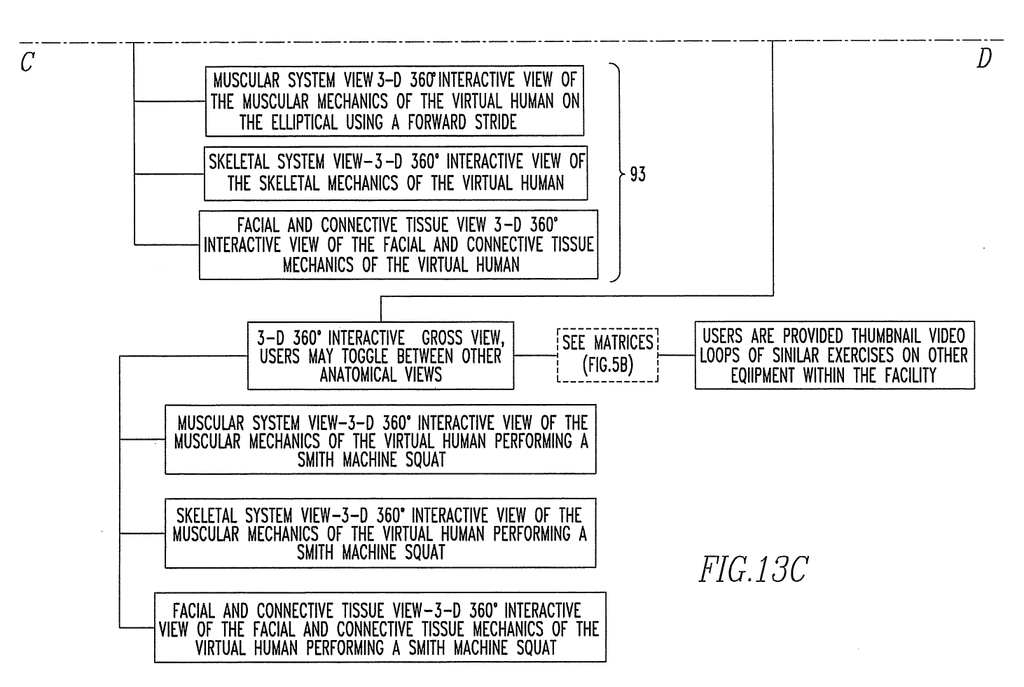

With reference to FIG. 13, and with continuing reference to FIGS. 1-4, the use of the HRS to view and retrieve information on facility strength-training equipment by an on-site user is illustrated. In this instance the user uses the system introduction link 63c and chooses to take a virtual tour 67a of the facility and retrieves further information on specific equipment within the free weight and machine weight area of exercise facility 5 or 7.

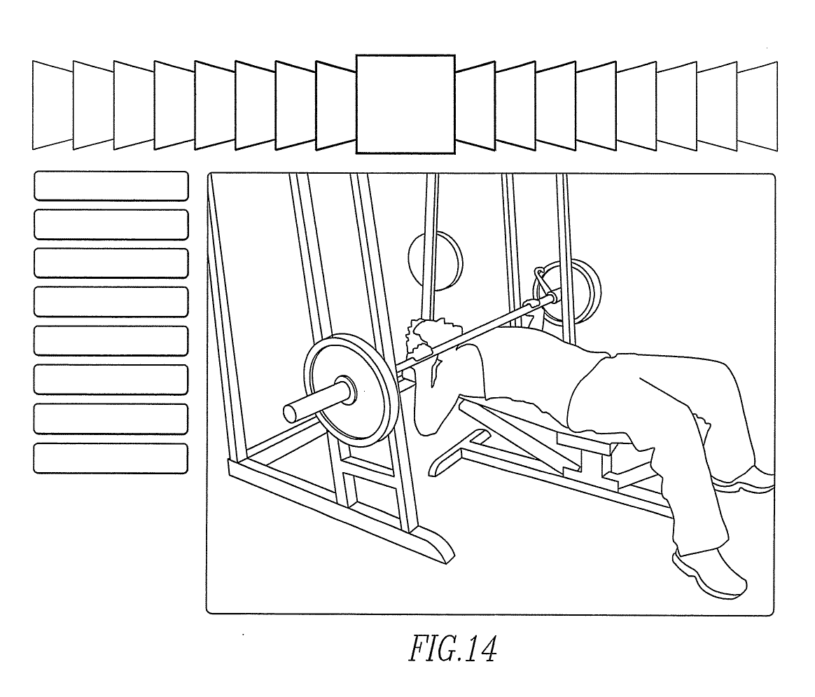

At blocks 85, the user has the ability to select any individual piece of equipment from the virtual tour or the overhead floor plan for further information. At blocks 87, the user can then select from pieces of equipment that can be viewed within the free weight and machine weight area as viewed through the virtual tour and/or overhead floor plan view. Once the user selects a specific piece of equipment, such as the Smith Machine, the user is presented with a plurality of movements and exercises available on the equipment touch-selected from the free weight area (see blocks 89). As shown in FIG. 14, the user is then presented with an isolated view of a virtual human performing an exercise on the selected equipment, in this case a Smith Machine chest press. At block 91, system 1 presents the user with equipment and/or movements similar, or deemed related, to that of the Smith Machine chest press as was described with relation to the Matrices shown in FIG. 5.

Another feature is that system 1 can show the virtual human performing the chest press from a Muscular system view. Within this view muscle action specific to the use of the elliptical is highlighted and explained (see FIG. 12). System 1 is also capable of showing the virtual human performing the chest press from a Skeletal system view. Within this view, skeletal action specific to the use of the elliptical is highlighted and explained. Finally, system 1 has the ability to show the virtual human performing the chest press from a Fascial and Connective Tissue view. Within this view, fascial and connective tissue action specific to the use of the elliptical is highlighted and explained (see blocks 93).

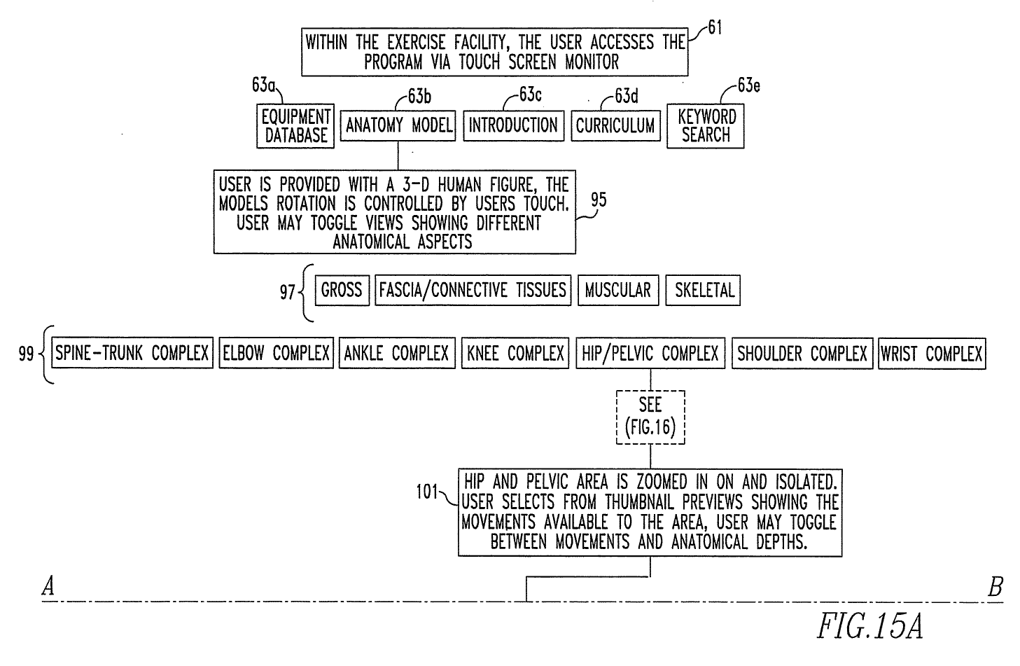

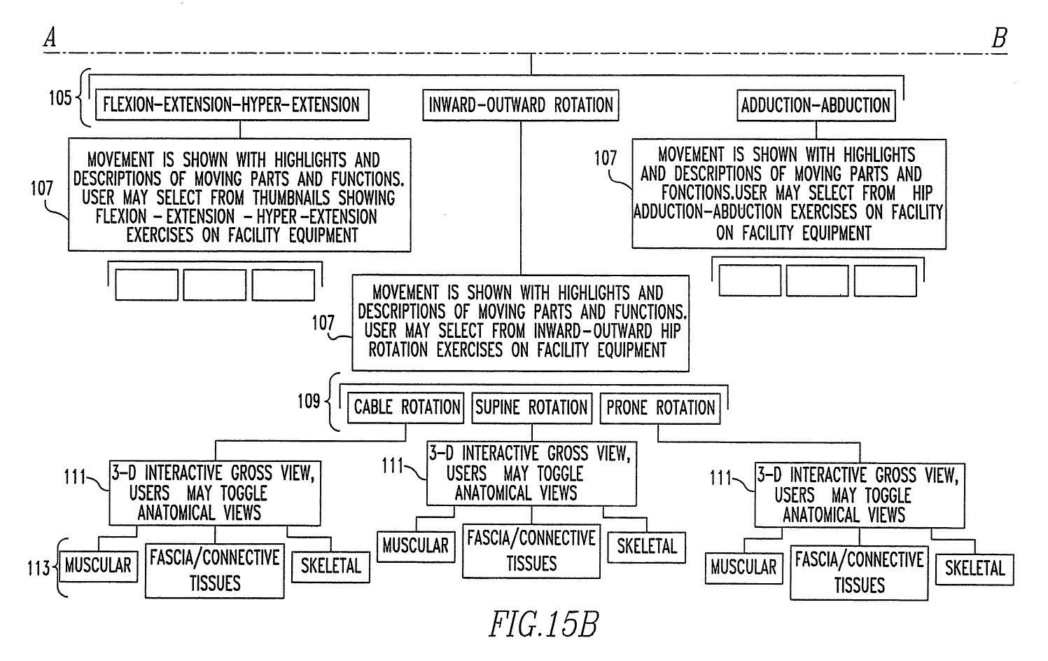

With reference to FIG. 15, and with continuing reference to FIGS. 1-4, a flow-diagram illustrating the use of the anatomy model 63b of the system of the present invention is provided. In this instance, a user is referring to the HRS to learn more about an area of the body (e.g., the hip and pelvic complex).

The method used by the user to retrieve information from anatomy model 63b is as follows: first, at step 61, the user within exercise facility 5 or 7 activates the HRS by touching the screen on user interface 5a or 7a thereby providing a home screen from which the user may select from the links available. These links include, but are not limited to, equipment database 63a having information related to facility equipment, anatomy model 63b utilizing a virtual human to demonstrate the areas of the body used on facility equipment and during movement, an introduction 63c which contains a plurality of educational tutorials and walk-throughs for users, curriculum 63d having educational tutorials regarding exercise science and a keyword search 63e which allows the user to search central database 3. The user then selects anatomy model 63b.

Within the area of anatomy model 63b, a human anatomy model is provided in the default setting (see block 95). A user's touch on the touch-screen highlights specific body areas and provides a pop-up description explaining what underlying structures are available for further study. At blocks 97, the user may select from the aforementioned description pop-up of local anatomical structures or toggle between the several views of different anatomical depths, for example, Gross, Fascial/Connective Tissue, Muscular, and Skeletal. When the user decides to toggle views, the anatomical depth chosen becomes the depth which the human anatomy model is displayed. Again a user's touch on the touch-screen may select specific body areas, resulting in a pop-up with the explanation of local structures.

At any point the user may select a zoom function to further highlight specific areas of interest within human anatomy. The zoom function allows detailed study of the joint complexes of the body (e.g., elbow, ankle, knee, hip/pelvis, shoulder and wrist). From the screen providing a magnified perspective, the touch-highlighted description pop-ups become more specific in regard to the individual local structures that are available within the current anatomical depth (see blocks 99).

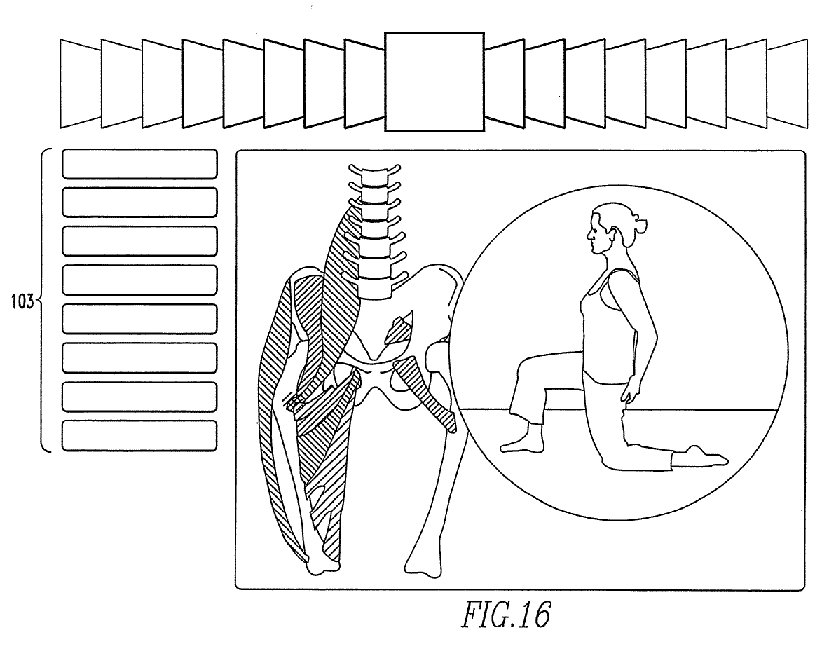

At block 101, when the user selects a particular area to study (via zoom) regardless of the anatomical depth, a column is offered displaying animation of the movements available to that particular area (see FIG. 16, element 103). The user may now select from the movements provided while still viewing the isolated area for further study. In this example, the user has selected the ‘hip/pelvic complex’ of the human model, and is provided a view of this area alone in any of the four depths previously mentioned. From the Gross view, the user is provided a skin depth view from the mid-point of the thigh to the superior iliac crest in a 360 degree model. The Fascial/Connective Tissues view provides an image of fascial lines in a 360 degree model. The selection of the Muscular view provides a 360 degree model of the hip/pelvic complex's most inferior aspect of muscle to the most superior aspects that act through the joint complex, (also the deepest to the most superficial aspects). Skeletal view provides a 360 degree model of the skeletal aspects of the femur, hip and pelvis.

At blocks 105, the column on the screen providing animation of available articulations contains, for example, Flexion and Extension animation, Inward and Outward Rotation animation, and Abduction and Adduction animation of the hip and pelvic joint complex.

When a user selects a specific articulation at block 107, that movement is presented full-screen. Touch highlights specific anatomical aspect articulation with ‘Focus Points’. For example, during inward and outward rotation of the hip, the role of the shortening and lengthening of the obtorator is noted when the user places his/her finger over it in the Muscular view. If in Fascial and Connective Tissue view, highlight of the same area would reveal the fascial line direction of pull.

With reference to blocks 109, while viewing an area's articulation, the side column of the screen provides animation of exercises that may be performed using facility equipment expressing the same articulation as the current screen, for example, supine rotation, prone rotation, and cable rotation may be shown. Taking the place of the articulation animation is the user's selection of the exercise involving Hip/Pelvis Inward/Outward Rotation. The central screen image is then the anatomy model performing the inward/outward hip rotation exercise as selected by the user. Anatomical depths may again be toggled to reveal the exercise mechanics at all levels. Alternate exercises providing the same and/or similar articulations are provided as thumbnail animations on the side screen column (see blocks 111). Each exercise may be viewed in the available levels of anatomical depth (see blocks 113).

At any time, the user may select the facility navigation link to view exactly where that particular exercise may be performed within the facility. The overhead floor plan will show a highlighted equipment location the user may choose to use first-person video simulation to walk through the facility to the equipment's location.

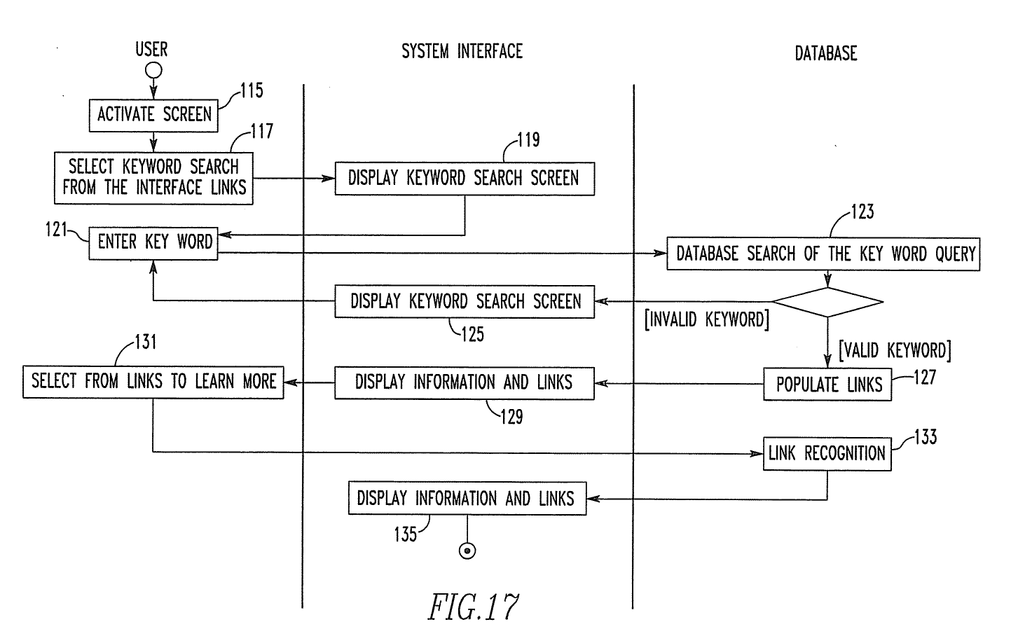

With reference to FIG. 17, the actions of the user, facility interface 5a or 7a, and central database 3 are shown in the depiction of a Keyword Search function. First, at 115, a user within an exercise facility 5 or 7 activates the touch-screen of facility interface 5a or 7a. The user may also perform the same function using their personal computer or any device with Internet access. Next, at 117, the user touch-selects Keyword Search link 63e from the Home-screen. Thereafter, at 119, system 1 displays a Keyword Search screen. The user then enters a keyword in the entry box using an on-screen keyboard or physical keyboard (see 121). Next, at 123, the keyword is queried within central database 3. If the search was invalid, the user is again presented with the Keyword Search screen at 125. If the Keyword Search was recognized, central database 3 populates the links applying to the keyword (see 127). Facility interface 5a or 7a then displays the links along with additional text within the context that the keyword was found (see 129). Thereafter, the user may select a link to view in full (see 131). Central database 3 loads the selected link information (see 133) and facility interface 5a or 7a presents the user with the selected section (see 135).

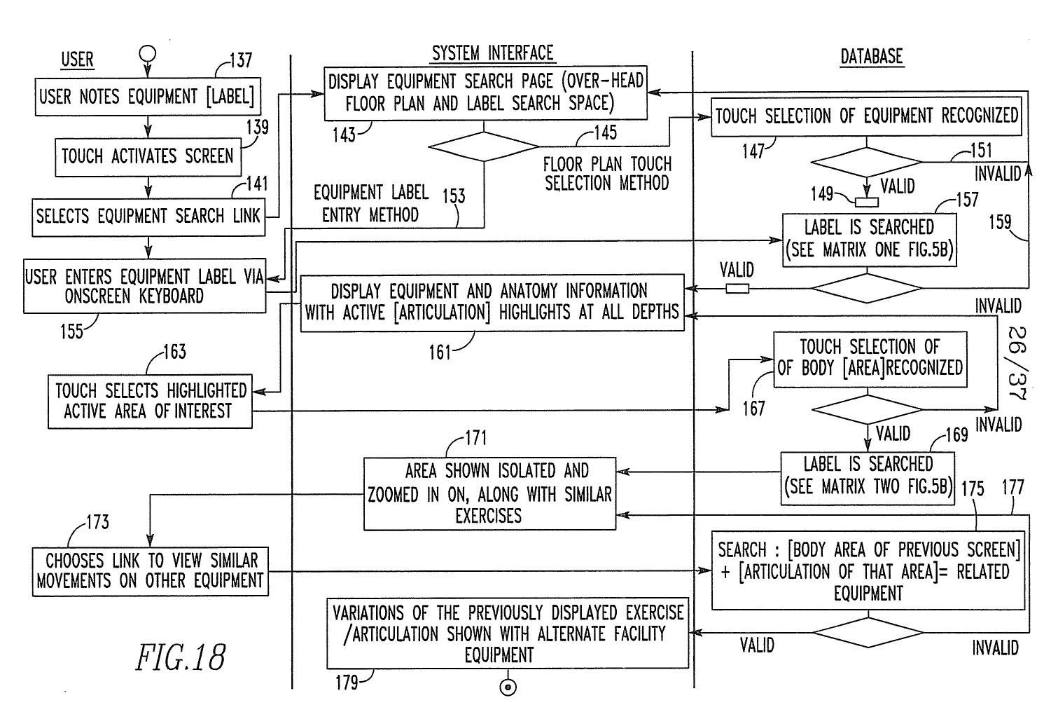

With reference to FIG. 18, the actions of the user, facility interface 5a or 7a and central database 3 are shown in the depiction of an Equipment Search function. First, if a user within an exercise facility 5 or 7 wishes to learn about a piece of exercise equipment, a facility amenity, or a facility area the user notes the label assigned to his interest at 137. The user may also perform the same function using their personal computer or any device with Internet access. Then, at 139, a user within an exercise facility 5 or 7 activates the touch-screen of facility interface 5a or 7a. Next, at 141, the user touch-selects equipment database link 63a from the Home-screen. Thereafter, at 143, the equipment database page is presented in an overhead rendering of the facility layout, along with an area for entering the label. The user may then touch-select a piece of equipment, amenity, or facility area by tapping the screen where the image is displayed (see 145). Next, central database 3 attempts to recognize the touch-selection (see 147). If the touch selection is recognized, the label corresponding to the users touch-selection is searched (see 149). If the selection is unrecognized, system 1 returns to the previous screen (see 151).

Alternatively, the user may enter the label assigned to the equipment (see 153). This technique is helpful for small and transportable equipment that is unable to be accurately represented by the layout rendering (see FIG. 7 or FIG. 10) and non-equipment searches such as areas and amenities. First, at 155, the user enters the label via an on-screen keyboard or physical keyboard. At 157, the label entered by the user is searched if the entered label is recognized using Matrix One shown in FIG. 5. If the user's entry is unrecognized, system 1 returns to the previous screen (see 159). If the entered label is recognized, system 1 displays the equipment and animations of its use at 161. Highlights of the articulation specific to the equipment are also shown on the anatomy model as discussed previously.

The user, at 163, may then touch-select an area of the anatomy model shown using the equipment to learn more about the functions of the selected area during the performance of the exercise. If the touch-selection is unrecognized, system 1 returns to the previous screen at 165. If the touch-selection is recognized at 167, the label corresponding to the touch selection is searched using Matrix Two shown in FIG. 5 at 169 and other equipment providing a combination of the previously displayed area and articulation also generated by the search. System 1, at 171, then displays the selected area in more detail within a focused view. Information and highlights are shown explaining the anatomical aspects and articulations at all depths, as described in previous models. An articulation of the same area on other pieces of facility equipment is displayed in a column of thumbnail animations when available. At 173, the user may select from the column along the border of the page depicting animations of similar articulation on other equipment within the facility by tapping over the thumbnail he wishes to view in more detail. Next, at 175, central database 3 retrieves equipment that shares the attributes of the previous screen's body area shown and the articulation of that area thereby populating a list of all matches. If no matching combinations exist, system 1 returns to the previous screen at 177. If a combination exists, the results are returned and resulting exercise animations are shown on alternate facility equipment (see 179).

At this time, the user may select from the related equipment thus repeating the aforementioned process. The user may view the equipment's location in the facility. The user may choose to begin a new search or exit the search area of the HRS, returning to the Home-screen.

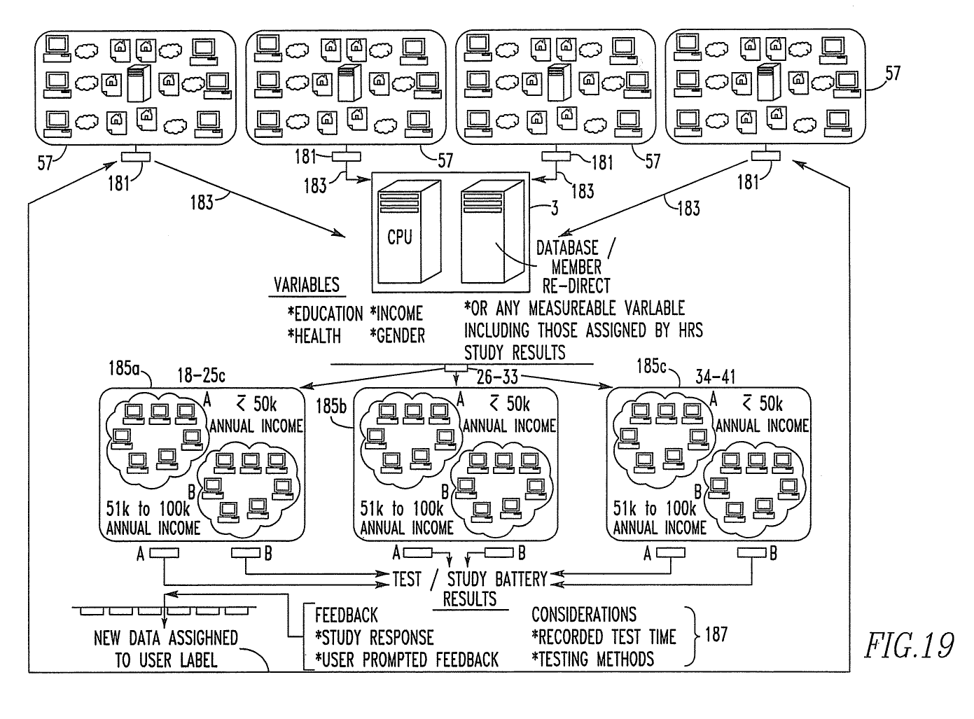

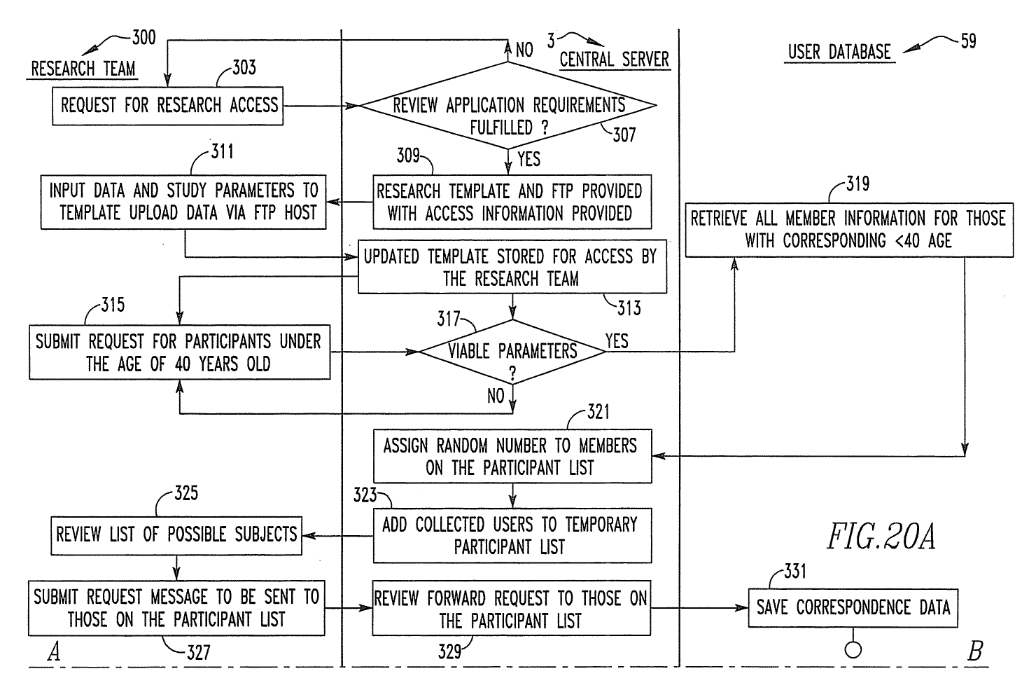

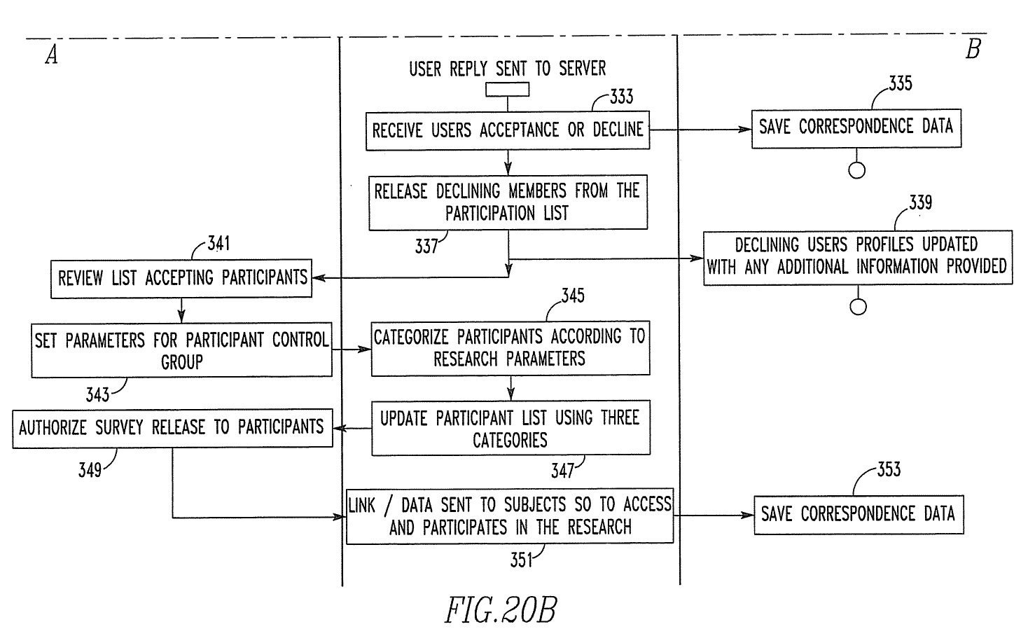

With reference to FIG. 19, system 1 of the present invention also has the ability to provide an environment fostering scientific study and research. The HRS can create access to anonymous groups and individuals categorized by user-provided data. Categories may be determined by any number of socioeconomic and other measurable variables provided by the user. Observational, randomized, case-controlled trials and other research and study methods are made possible with the introduction of the HRS and the controlled environment of host facilities. The HRS capabilities will be of special interest to those involved in the study of health informatics, the social sciences and others.

As discussed hereinabove, the users are members of networks 57 comprising other users within an appropriate distance of HRS host facilities. In order to maintain the user's anonymity, each user is provided a username 181 or some unrelated reference title (e.g., label, IP Address) recognized only by central database 3 according to specific study or event parameters set forth by the primary investigator or educator. As represented by arrow 183, user information is retrieved by central database 3. Study participants (i.e., the users) are categorized according to the information they have provided. Recognition of the anonymous participant's label yields the generation of a subject data table accessible to a primary investigator. A database is constructed based on study determinants set forth by the primary investigator. The study determinants may include socioeconomic, demographic, and other variables.

For example, using study determinants, the users may be divided into three groups 185a, 185b and 185c where each group has two subgroups. Group 185a has participants within the ages of eighteen and twenty-five divided into: 1) subgroup ‘A’ having an annual income of less than or equal to $50,000; and 2) subgroup ‘B’ having an annual income of $51,000 to $100,000. Group 185b has participants within the ages of twenty-six and thirty-three divided into: 1) subgroup ‘A’ having an annual income of less than or equal to $50,000; and 2) subgroup ‘B’ having an annual income of $51,000 to $100,000. Group 185c has participants within the ages of thirty-four and forty-one divided into: 1) subgroup ‘A’ having an annual income of less than or equal to $50,000; and 2) subgroup ‘B’ having an annual income of $51,000 to $100,000. All users may participate in the study anonymously as previously stated. With access to the Internet (offered within exercise facilities 5 or 7 and any device with Internet access), participants interact with the HRS according to the study determinants.

The study output 187 may be in the form of participant interaction or feedback such as survey, test, and activity results. Other conditions may be taken into account such as specific question/answer response time, test taking methods applied by the user and others. Additionally, interaction may be observed and results collected, both according to study groups and subgroups. Resulting quantifiable data gathered may be applied to the anonymous user's reference title (i.e., username, label, etc.).

Another example of how the system of the present can aid in study and research will be discussed hereinafter. Currently, a majority of research protocols require respondent subjects to use a computer which carries out required tasks as designed by the researchers. This may be referred to as Computer Assisted Personal Interviewing (CAPI). Most often a computer lab is set up and respondents visit and provide their time in exchange for a small reimbursement of money. The money provided as reimbursement to subjects is raised first by researchers who find funding for their research. This is a long and expensive process. Due to the financial and time constraints experienced by researchers, protocols are often prematurely completed. In other words, if the researchers had been able to continue their work for a longer period of time, the quality of the resulting data may have increased exponentially.

The system of the present invention, with its broad infrastructure and user base, will allow for wide ranging degrees of new research. The ability to test and compare the effectiveness of computer based teaching methods versus paper based methods is one such capability. In addition, the ability to employ measurements and maintain the storage and re-application of resulting data is allowed for by the system of the present invention.

The system of the present invention provides an opportunity for new research capabilities. Since research requires large amounts of respondents or subjects, respondent availability and continued subject interaction, current research methods are costly and are often unable to extend beyond a few months. The system of the present invention takes advantage of a social setting, such as a fitness center, and provides avenues for the users to learn while researchers test and measure. Due to the continued interaction of facility members with the system of the present invention, research protocols may be carried out over extended periods of time, new information may be gathered, and advances in Internet and information science will be realized.

The system of the present invention allows for unique studies comparing the effects of different methods of information delivery, content, and how information presentation is related to the valuation of data, the application of a truth-value, its objectivity, and its accessibility. These research interests are of particular importance within anomalistic psychology, cognitive measurements, memory research, consumer research, social and decision science, also information science and Internet science. However, this list is not to be construed as limiting the present invention as the use of the present invention in various other researching contexts. By measuring and monitoring users' truth/logic ratings of hypothetical third party anecdotes, testimonials and experience descriptions, researchers can test what types of information and delivery methods produce quantitative change in users' susceptibility to faulty advertisements, unethical medical claims, and the like.

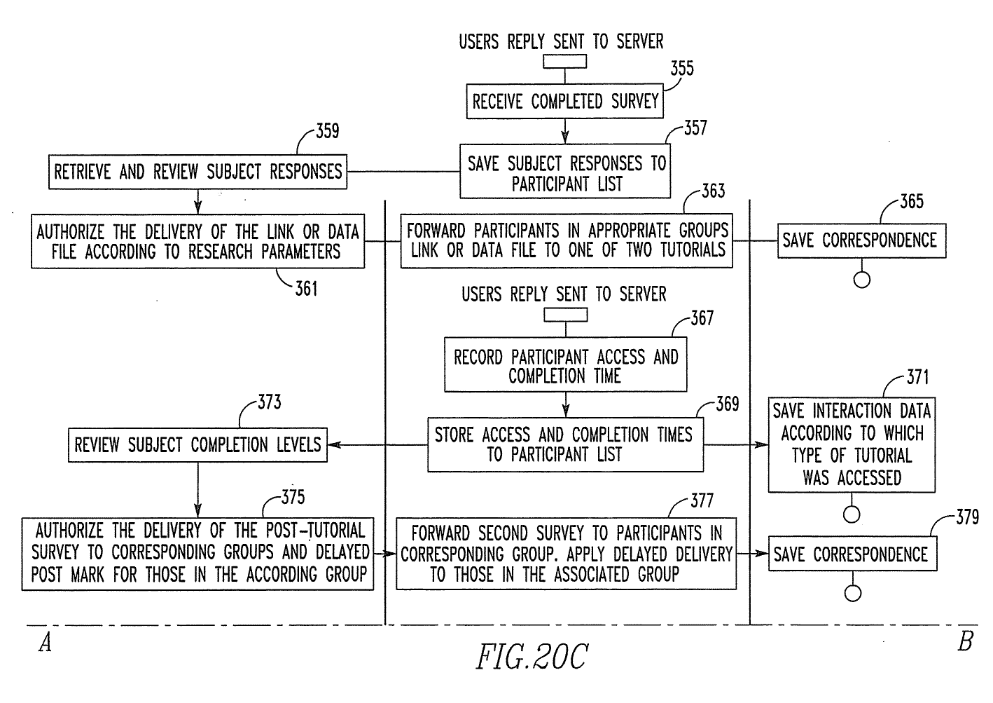

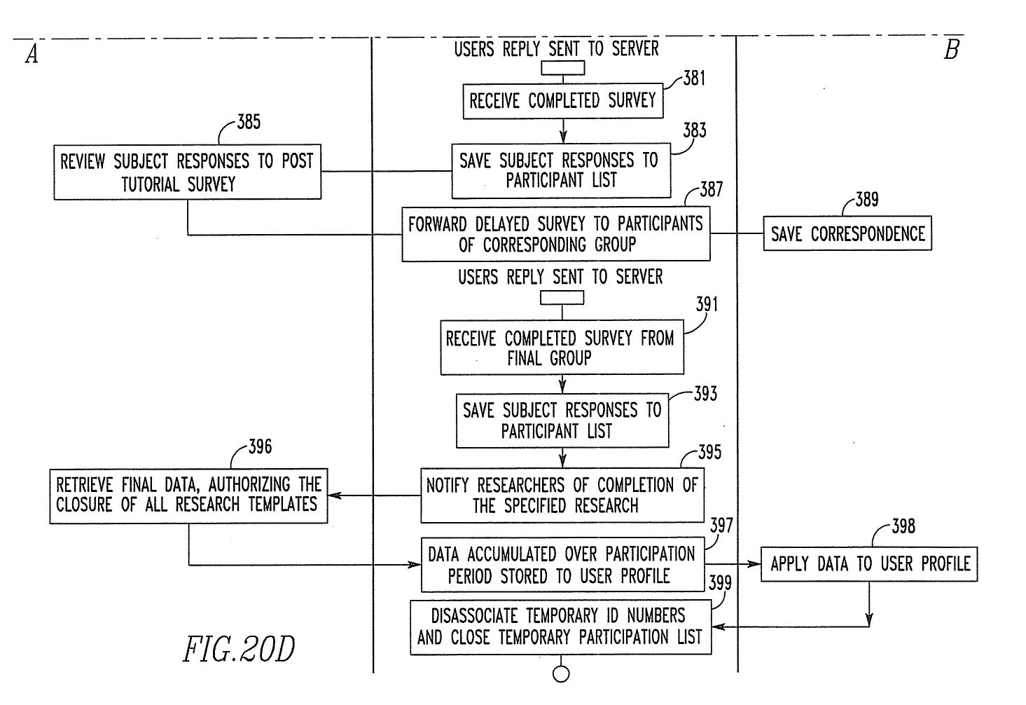

With reference to FIGS. 20A and 20B, a flow-diagram illustrating the interactions between a team of researchers 300, central server 3 and a database/server 59 which maintains information on members is provided. Central server 3 hosts the interfaces for the research and member (subject) accounts. It also provides storage, upload and download capabilities while acting as the liaison between researchers 300 and anonymous participants. The interactions illustrated in this flow-diagram are those of a research team in its use of the HRS to carry out a study which applies multimedia tutorials and uses a survey method to test the effects of information delivered in the tutorial. The surveys in this example may be text and graphic based. Central server 3 and user database 59 are maintained in a static physical location, such as an exercise facility 5 or 7, while the research team 300 may be located anywhere with access to the HRS utilities and facilities if needed.

A non-limiting example of the type of research that may be conducted using the system of the present invention is a research protocol studying the effects that a self-directed multimedia tutorial about the use of scientific reasoning, for instance, has on participants' ability to recognize advertisements using fundamentally flawed statistics and testimonials. This may be considered consumer research. The research requires three groups of participants. Two groups will be selected to respond to pre-tutorial and post-tutorial surveys. One group will be selected to receive the same surveys with a delayed delivery of the post-tutorial survey. Of the two groups receiving immediate post-tutorial surveys, only one will receive a link or data file providing a tutorial about the use of scientific reasoning, the other group will receive a link or data file providing an unrelated tutorial, for example, a tutorial about exercise moderation.

The “groups” discussed above do not exist in a physical sense, but are pairings of anonymous participation data according to the requirements of research protocols. Members of one group may live across the country from one another, and members of separate groups may be members within the same physical facility. Please note that the preceding description is for exemplary purposes only and is not to be construed as limiting the present invention.

With continued reference to FIGS. 20A and 20B, at step 303, research team 300 with proposed study goals provides a review of the research agenda and any viable information for effective hosting by HRS 1. Just as members may add and create user profiles via the user interfaces of HRS 1, the research team may create and manage their accounts via a research interface provided by HRS 1. At step 305, the submitted proposal is retrieved by central server 3 and data points are reviewed to ensure compatibility with the hosting capabilities of HRS 1. At decision block 307, if the application requirements have not been met, the research application is declined and returned to the research team. If the application is accepted, the interaction continues.

At step 309, upon acceptance of a research application, a template is generated with data provided from the application applied to it. This template becomes the research team interface allowing the ability to upload, retrieve, and manage files for the study. The research team 300 then receives a correspondence explaining how to access and continue their use of HRS 1. At step 311, with access to the research interface, members of the research team 300 may monitor, modify and upload new information, files, links, and research parameters. As updates are made from the research interface, they are stored at step 313 within a central server node responsible for the maintenance of the account. Thereafter, the research team may now, at step 315, submit real time requests to central server 3 for the collection of participants according to set parameters provided by research team 300. For example, the study parameters may require participants under the age of forty. At decision block 317, if the outlined parameters requested by research team 300 are not compatible with the usage standards of HRS 1, the request is denied. If the request is accepted, interaction continues.

At step 319, characteristics requested by research team 300 are compared to data points provided by members. Combinations are retrieved and returned to the central server 3. Each retrieved member is assigned a random call number at step 321 which will replace any personal information relating the member to the voluntary information provided. At step 323, numbers and information of the retrieved members are added to a temporary list of participants accessible to research team 300. From the research interface, research team 300 is able to review the collection of possible participants at step 325. Thereafter, research team 300 may submit an invitation for participation for delivery to the members displayed in the list of possible participants at step 327. At step 329, the invitation is reviewed and forwarded the central server 3 to those members populating the possible participant list. Correspondence data such as date, retrieval time, request and response are stored to the user's information profile for future analysis at step 331.

At step 333, user responses to the invitation are received by central server 3. The acceptance or refusal to participate is stored to the user's information profile at step 335. When a user declines participation, that user is removed from the list of participants at step 337. The release from a list of possible participants allows the user's information to be queried by other subject searches as in steps 317 and 319. Any additional information provided by the user is added to the information profile at step 339. At step 341, research team 300 may review the collection of accepting members. Thereafter and at step 343, research team 300 may submit the final parameters for the division of the participants into groups according to the needs of the study. At step 345, subject groupings are applied to the list of participants. The participant list is then divided into the required format as outlined in the research parameters at step 347. Research team 300 may now authorize the release of the first survey for deliver to the participants at step 349. Once the central server 3 receives the order to release the data to the subjects, the appropriate information is provided to the participants at step 351. This information may come in the form of a link, a downloadable data file, or any suitable information delivery method required for the executions of the study, including the use of the physical facility to which the user is enrolled. Correspondence data is thereafter stored within the user information profile at step 353.

Thereafter and at step 355, central server 3 collects incoming replies from the users/subjects. This may also come in the form of a link, a data file, physical recording of data, or any other suitable medium. The results collected are applied to the list of anonymous participants for the access of research team 300 at step 357. Members of research team 300 may then review the results of the first survey from their research interface at step 359. When research team 300 has determined that sufficient survey data has been collected, they may, at step 361, authorize the release of the next stage of information delivery to the subjects. In this example, it is one of two possible tutorials. However, this is not to be construed as limiting the present invention as any number of tutorials may be utilized. In this non-limiting example of the present invention, at step 363, two groups will be forwarded a link, data file, or any other suitable type of information delivery allowing the interaction with tutorial type A, while one group will receive a link, data file, or other suitable type of information delivery allowing the interaction with tutorial type B. Then, at step 365, correspondence data is saved to the user information profile.

A user from his/her personal interface can then access the data. This action will be recorded, at step 367, by central server 3 along with completion time and any additional information provided. The resulting completion rates of the tutorials will be applied to the participant list at step 369. Thereafter, the interaction with the designed tutorial is stored to the user information profile for reference in future requests for participation at step 371 and researchers may monitor and review the completion rates at step 373. When research team 300 has determined that a sufficient amount of subject interactions with the tutorial have taken place, they may authorize the release of the next survey to subjects within the two groups assigned an immediate post-tutorial survey at step 375. The second stage of information retrieval is continued just as the first with central server 3 forwarding the link, data file or other information modality to subjects in the two groups designed to receive immediate post-tutorial survey at step 377. A delay is placed on the delivery to subjects within the third group. Correspondence data is thereafter saved, at step 379, to the user information profile.

Central server 3 receives the completed surveys from subjects of the two receiving groups of participants at step 381 and the collected results are applied to the list of anonymous participants for the access of research team 300 at step 383. At step 385, members of research team 300 may review the results of the second survey from their research interface. Thereafter, at step 387, the final subject group is forwarded the post-tutorial survey. The correspondence data is then saved to the user information profile at step 389.

Next, central server 300 receives the completed surveys from subjects of the last receiving group of participants at step 391 and the collected results are applied to the list of anonymous participants for the access of research team 300 at step 393. At step 395, a notice of completion is generated and forwarded to the research team interface. Members of research team 300 may review the results of the last survey from their research interface. After this review, members of the research team 300 authorize the closure of all research templates at step 396. At step 397, data collected over the period of participation is applied to the subjects on the participation list. Thereafter, data is applied to the users' information profile at step 398. Finally, at step 399, all associations between randomly assigned referral numbers and subjects are discontinued. The release of all participants allows the users information to be queried by other subject searches as in steps 317 and 319.

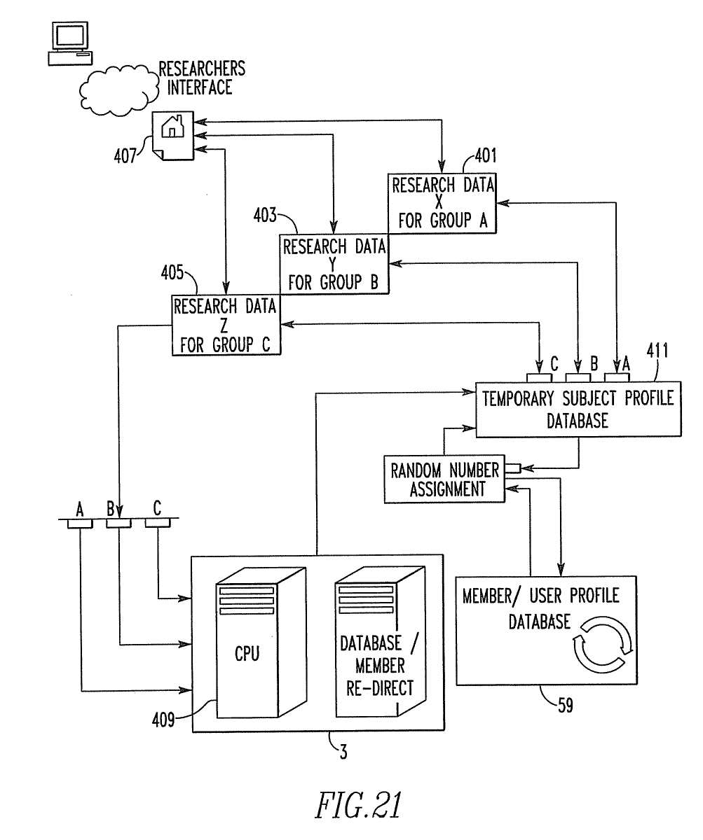

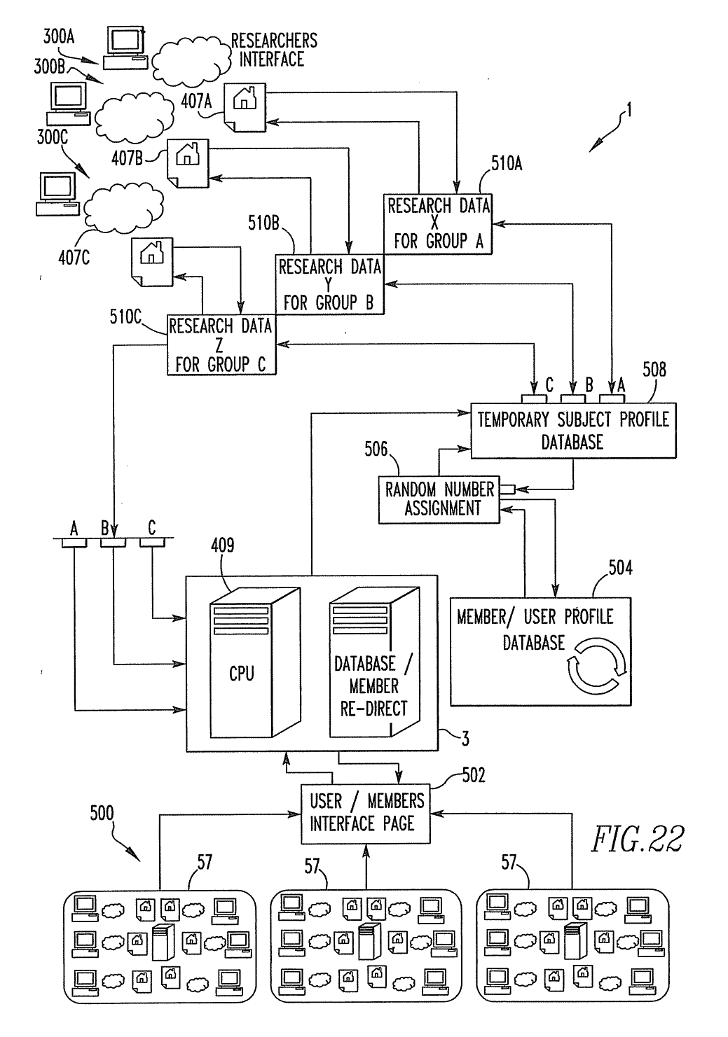

With reference to FIG. 21, an exemplary embodiment of system 1 of the present invention being utilized for research is provided. This figure depicts the interaction of a research protocol involving three separate groups of subjects and their reception of separate data from research team 300. The organization of subjects in relation to their corresponding participation with research is a fundamental ability of the invention. The comparison of different web-based curriculum formats can be achieved by employing Method X to a group of users A, Method Y to a group of users B, and Method Z to a group of users C. Methods of measurement may include, but are not limited to, subject correct percentages on survey responses, interviews before, during and after information delivery periods, and follow-up long-term surveys. This function of the invention allows the ability to compare effectiveness of information delivery, ratings of self-efficacy, and information recall among a myriad of other measurable outcomes.

The system 1 of the present invention when used for research includes a plurality of file hosting nodes 401, 403, and 405. File hosting nodes 401, 403, and 405 are provided to a team of researchers 300 and are accessible to them through a research interface 407. File hosting node 401 may, for instance, be configured to maintain research data in accordance with participants that have been assigned to interact with it. In this node, data of a type “X” is categorized in its interactions with participants of a group “A”. File hosting node 403 may, for instance, be configured to maintain research data in accordance with participants that have been assigned to interact with it. In this node, data of a type “Y” is categorized in its interactions with participants of a group “B”. File hosting node 405 may also be configured to maintain research data in accordance with participants that have been assigned to interact with it. In this node, data of a type “Z” is categorized in its interactions with participants of a group “C”.

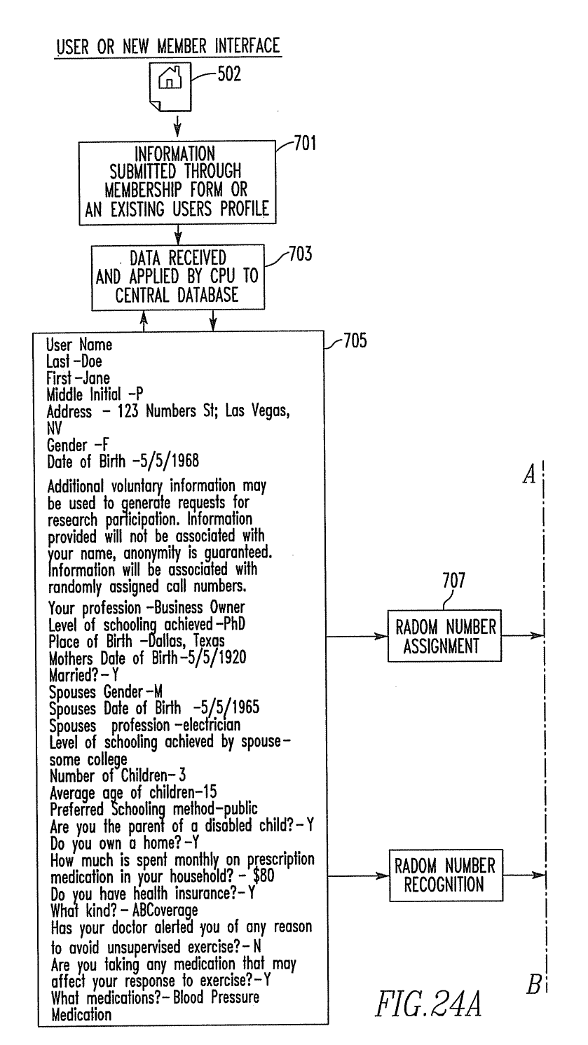

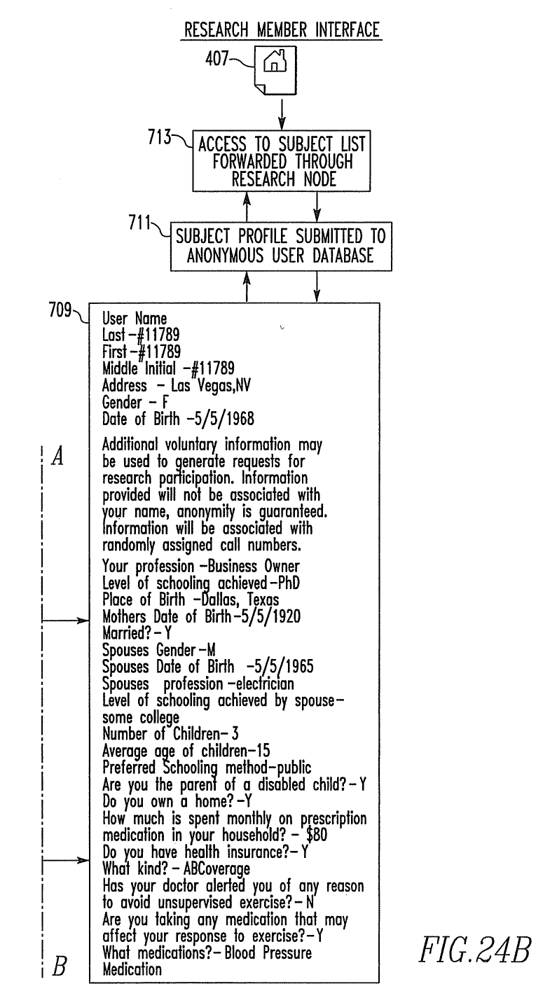

When information is uploaded by researchers for the purpose of allowing participants to interact with it, it is collected for review within a central processing unit 409 of central server 3. In order to maintain study and user anonymity standards, all information received from file hosting nodes 401, 403, 405 is directed through individual pathways to be reviewed and applied to user databases. Central server 3 acts as a host by negotiating interactions between the information provided by researchers and the information able to be accessed by participants. As described hereinabove with reference to FIGS. 20A and 20B once a research account has been created, interactions between researcher interface 407 and central server 3 are directed to corresponding nodes as outlined by the research parameters. The forwarding of data of type “X” to members of group “A”, and not groups “B” and “C”; data of type “Y” to members of group “B”, and not groups “A” and “C”; and data of type “Z” to members of group “C” and not groups “A” and “B” is made possible by the recognition of the nodes 401, 403, or 405 from which the data has been received as explained hereinabove. Anonymous subject profiles are stored in a separate, anonymous database 411 and subdivided into nodes created for the use of individual research teams, as will be discussed hereinafter with reference to FIG. 24. Participants within studies are organized according to these nodes, and information provided by subjects is associated with the node assigned to their profile. Data received from user (member, subject) interaction with their interface (in the form of correspondence and interaction with surveys, questionnaires, and interviews implemented by the research team) is directly applied to the nodes to which they are assigned within the anonymous database 411 and interactions are thereby directly applied to the file hosting nodes and interface of the research team. A research team 300 may re-apply information to the users' anonymous profile for the use of future research participant request queries. This enables the minimization of cross-study biases common amongst frequent participants in research protocols.

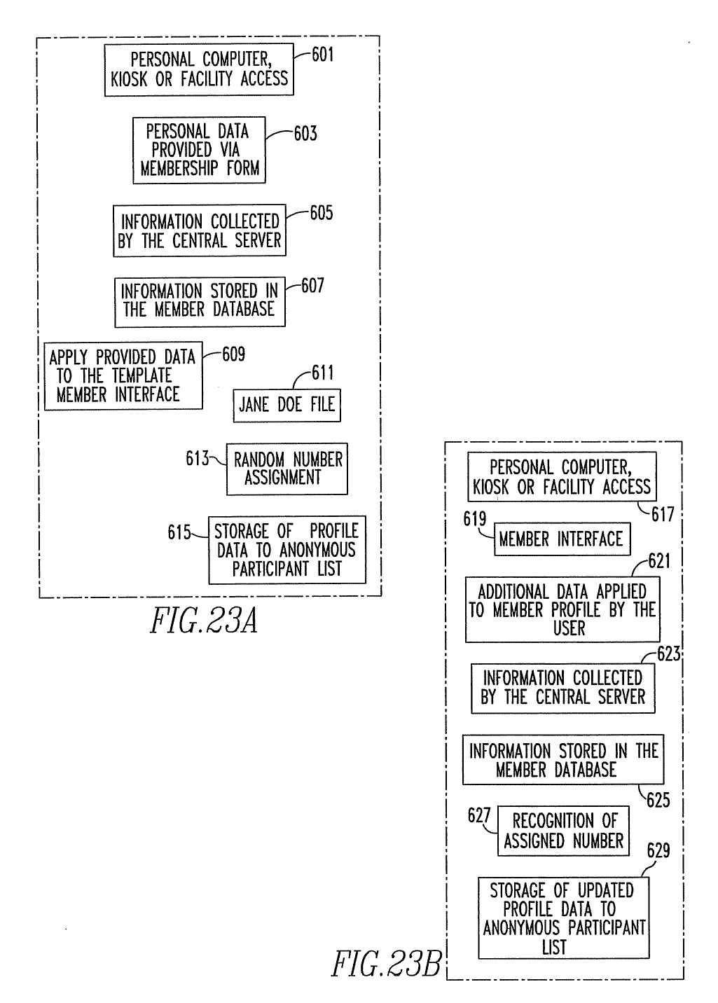

With reference to FIG. 22, an alternative embodiment of system HRS 1 being used for research is illustrated. The system includes a facility network 57. Facility network 57 is made up of many members from the facilities located within a determined distance from each other (e.g., all facilities within an area code, etc.). This allows members the ability to network with others who may not share a membership to the same facility but live within a relatively small distance of one another. A plurality of facility networks 57 can be networked together to form an overall network 500. All members from each facility network 57 interact with their own personalized interface 502 which is customized from the template provided at the time of sign-up as described with reference to FIG. 3. When log-in information is provided, the central processing unit 409 of central server 3 is responsible for recognizing the members' corresponding facility location and routing them to the correct network server according to this information. A database 504 exists which is responsible for maintaining user information as it is provided. This database 504 is able to be queried by central server 3 as requested by researchers. This database 504 is assessable only to central server 3. Individuals may access their own member information maintained by database 504 through personal interface 502. The system 1 of the present invention has the ability to maintain user anonymity during subject queries as requested by researchers. As combinations between requested datum and stored subject datum are retrieved, random numbers are applied to personal data by a random number generator 506. Anonymous subject profiles are stored in a separate temporary subject profile database 508 created for the use of individual research teams. Individual profile data saved within the temporary subject profile database 508 may be increased through user interaction with their profiles (via user interface 502) and their interaction with research protocols. Updated information attained through interaction with a research protocol is recognized by the assigned number. Information collected is re-applied to the permanent user database 504 which is continuously updated. Any time the user connects to their interface 502, he or she may retrieve, view and update his or her profile.

In addition, at any time several research teams may have access to HRS 1. In the exemplary embodiment of FIG. 22, three separate studies are being conducted by research teams 300A, 300B, and 300C, who may use a personal computer or a facility-based system to connect to their respective interface via the Internet. Each research team 300A, 300B, and 300C has its own interface 407A, 407B, and 407C, accessible to those in possession of log-in information provided at the time of research account creation. Each research team interface 407A, 407B, and 407C provides access to a node 510A, 510B, and 510C of central processing unit 409 which hosts the data uploaded by the research and data collected within the central processing unit 409 through interaction with members (subjects/users). Research teams 300A, 300B, and 300C may choose to upload text files, multimedia files, and/or full program files. Data collected through interaction between the subjects and the study files provided by the research team may be presented in text, multimedia, and/or full program files as determined by the research team. When information is uploaded by researchers, it is collected for review within the central processing unit 409. In order to maintain study and user anonymity standards, all information received from nodes 510A, 510B, and 510C is directed through individual pathways to be reviewed and applied to user databases. Subject information requested by researchers and provided by subject participation is routed from individual nodes 510A, 510B, and 510C, which are created for exchange with individual teams of researchers. This eliminates the risk of cross study contamination and secures user anonymity.

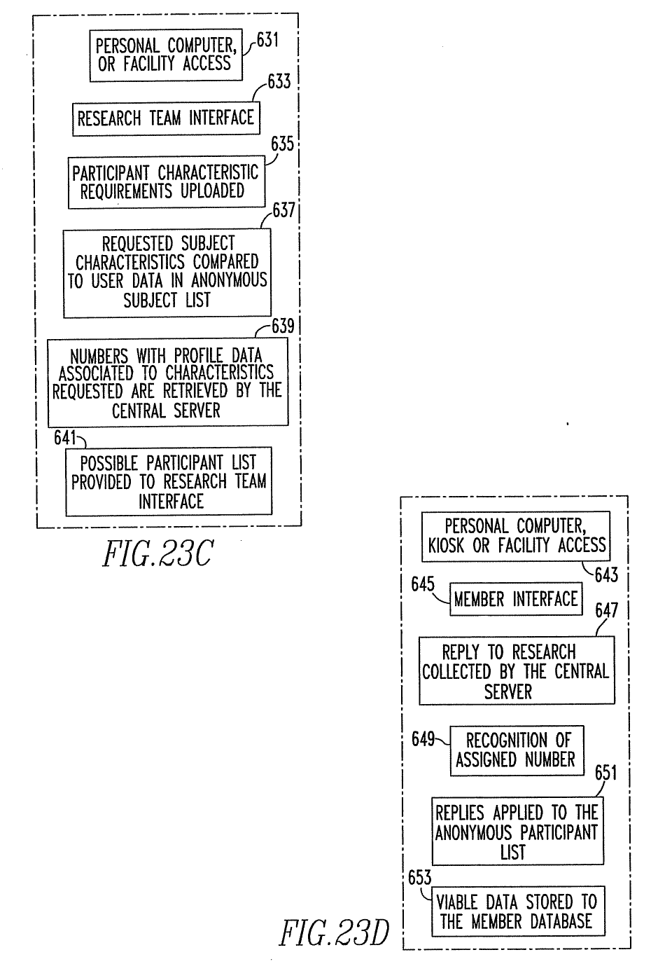

FIG. 23 provides a graphical representation of the steps required for the creation, collection, application, and updating of user information as discussed hereinabove. Quadrant A outlines the initial creation of a user information profile as a result of providing necessary information for membership. First, at blocks 601 through 607, information provided by a new user via a kiosk 9, facility based interface 5a, 7a, or a personal computer 11 is stored in a member database 504. At block 609, collected information is applied to a template created for the user's interaction with the HRS 1. At block 611, the user's information now exists within the database 504 as a unique file corresponding to the user's interface. Database files are collected and assigned with a unique number to which the file will be associated at block 613. This number replaces any information enabling the personal identification of the user. Once this unique number is assigned, the data may be stored, at block 615, in a separate database 508. This anonymous database 508 is queried when researchers request study participants with specific characteristics.

Quadrant B outlines the update of information applied to an existing user profile by the user. First, at block 617, a user may interact with HRS 1 features using a kiosk 9, facility based interface 5a, 7a, or a personal computer 11. Once a user has accessed their account, they may interact with their personal interface 502 at block 619. A user may choose to enter more information to the profile and update information provided in the past at block 621. At block 623, updates to the user interface 502 and profile data are collected by central processing unit 409 for storage and later retrieval. The database 504 responsible for maintaining user information is updated upon retrieval of new information at block 625. As information is added to the database 504, it is recognized according to the random number applied to it at block 627. Finally, at block 629, the information added by the user, having been updated within the main user database 504, is now updated within the anonymous participant database 508.

Quadrant C reviews an automated information retrieval and the creation of a new database. From a kiosk 9, facility based interface 5a, 7a, or a personal computer 11, a research team 300 with an existing user account may interact with the HRS features at block 631. A research team 300 interacts with HRS features via the research team interface 407 at block 633. The research team interface 407 is a template provided by HRS 1 and customized by research team 300 according to its needs. In this instance as provided at block 635, research team 300 uses its access to submit (i.e., upload to its ftp host) the requested characteristics and controls for study participants. At block 637, central processing unit 409 receives the request for data and is able to review for appropriate data points and compare with user data points within the anonymous subject database 508. At block 639, when combinations of data points are found, the information is retrieved and re-organized into a node for the accessibility of the research team. This temporarily disassociates the number and associated user data from the anonymous subject database 508, thereby avoiding conflicting requests for subjects. Finally, at block 641, the node containing the list of anonymous user points is provided to the research team for access via their interface. The team may review the data collected and may submit a request for further retrieval from the users, revise the characteristics and controls requested, or withdraw their request for participants.

Finally, quadrant D outlines the addition of information as it is collected by a subject's (user's) participation in responding to research. At block 643, a user may interact with HRS features using a kiosk 9, facility based interface 5a, 7a, or a personal computer 11. At block 645, once a user has accessed his or her account, he or she may interact with his or her personal interface 502. In this interaction, a user will receive a message requesting participation in research, and reply to the request by submitting a response. When a user replies to a research message, the information is collected by the central server 3 at block 647. Central server 3, upon receiving a response from an anonymous user, recognizes the number associated with the user at block 649. At block 651, the information is applied to the node associated with the assigned number of the user, thus allowing researchers with access to the node the ability to review the response and interact further. Finally, at block 653, an increased amount of data within the anonymous user database 508 prompts an update within the permanent user database 504, thus synchronizing information contained in the temporary node of anonymous users and the permanent user database 504.

With reference to FIG. 24, an illustration of the addition and storage of user data and its relations to research team data is provided. The ability to provide information, at step 701, is available to an existing member and to a new user. New users provide information via membership forms. Existing members provide additional data via their user interface 502. All information 705 submitted is routed through central server 3 for direction to a database 504 of user information at step 703. Information is encoded with a random number or other encoding method so to protect user identity at step 707 to provide encoded information 709. The encoded information 709 is stored within a database 508 with other collections of anonymous user data at step 711. At step 713, a node is provided for linking the anonymous user database 508 to the interface 407 of a research account. Research users may request limited access to anonymous user database 508, and submit data collected from user participation in research.

The same infrastructure enables research data collected (during interactions between anonymous participants and a research protocol) to be applied in a reverse order. Information received from a research participant is applied to the participant's file within the anonymous user database 508. Updates in the anonymous user database 508 are recognized and applied to the central server 3 to profiles corresponding with the random number.

These examples serve as a limited representation of the HRS utility enhancing the methods, quality, availability, development and application of important, low-cost, and effective public health studies. This example is not to be construed as limiting the present invention as any suitable study may be utilized. Studies may rely on the ability of the HRS to host a community based study, or comparative inter-community studies. Several different test batteries may be introduced simultaneously among groups and subgroups.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

The invention claimed is:

1. A system for delivering health science education and public health information to a user comprising:
a central database comprising information on health science education and public health information;
at least one exercise facility database coupled to the central database, the at least one exercise facility database located at an exercise facility;
at least one accessing device located within the exercise facility allowing a user to access the health science education and public health information from the exercise facility; and
at least one remote accessing device located at a remote location allowing a user to access the health science education and public health information on the central database from a remote location,
wherein health science education and public health information comprises user-controlled curriculums and tutorials featuring virtual learning approaches to exercise techniques and health science.

2. The system of claim 1, wherein the at least one remote accessing device is a personal computer at a home of the user.

3. The system of claim 1, wherein the at least one remote accessing device is a kiosk located at a remote location.

4. The system of claim 1, wherein the at least one accessing device is a touch-screen monitor, a kiosk or any combination thereof.

5. The system of claim 1, wherein the at least one exercise facility database and the at least one remote accessing device are coupled to the central database via the Internet.

6. A method of delivering health science education and public health information to a user, the method comprising the steps of:
creating a central database, the central database comprising information on health science education and public health information;
providing at least one exercise facility database at an exercise facility, the at least one exercise facility database is coupled to at least one accessing device and to the central database; and
providing at least one remote accessing device located at a remote location and coupled to the central database,
wherein the user is capable of accessing the health science education and public health information on the central database from either the at least one accessing device or the at least one remote accessing device to obtain the health science education and public health information, the health science education and public health information comprising user-controlled curriculums and tutorials featuring virtual learning approaches to exercise techniques and health science.

7. The method of claim 6, wherein the at least one remote accessing device is a personal computer at a home of the user.

8. The method of claim 6, wherein the at least one remote accessing device is a kiosk located at a remote location.

9. The method of claim 6, wherein the at least one accessing device is a touch-screen monitor, a kiosk or any combination thereof.

10. The method of claim 6, wherein the at least one exercise facility database and the at least one remote accessing device are coupled to the central database via the Internet.

11. A system for conducting research comprising:
a central server;
at least one exercise facility database coupled to the central server, the at least one exercise facility database located at an exercise facility and including information regarding each of the members of the exercise facility stored thereon;
at least one member interface device allowing at least one member to access the central server; and
at least one researcher interface allowing at least one researcher to access the central server and deliver research information to the member,
wherein the at least one researcher delivers research information to the at least one member via the central server and the at least one member provides responses to the research information to the at least one researcher via the central server.

12. The system for conducting research of claim 11, wherein the central server stores information on health science education and public health information.

13. The system for conducting research of claim 12, wherein the at least one member accesses the health science education and public health information on the central server using the at least one member interface device.

14. The system for conducting research of claim 12, wherein the health science education and public health information comprises user-controlled curriculums and tutorials featuring virtual learning approaches to exercise techniques and health science.

15. The system for conducting research of claim 11, wherein the at least one member interface device is a personal computer at a home of the user, a kiosk located at a remote location, a touch-screen monitor located at the exercise facility, a kiosk located at the exercise facility or any combination thereof.

16. The system for conducting research of claim 11, wherein the at least one researcher interface device is a personal computer.

17. The system for conducting research of claim 11, wherein the research information is a tutorial, a survey, a test or any combination thereof.

18. The system for conducting research of claim 11, wherein the at least one researcher interface device is coupled to the central server via the Internet.

19. The system for conducting research of claim 11, wherein the at least one member interface device is coupled to the central server via the Internet.

20. The system for conducting research of claim 11, wherein the at least one member interface device allows the at least one member to access the exercise facility database such that the at least one member can update information stored thereon.
